(19) United States
(12) Patent Application Publication
(10) Pub. No.: US 2013/0226813 A1
(43) Pub. Date: Aug. 29, 2013

(54) Cyberspace Identification Trust Authority (CITA) System and Method

(71) Applicant: Robert Matthew Voltz, Lansdowne, VA (US)

(72) Inventor: Robert Matthew Voltz, Lansdowne, VA (US)

(21) Appl. No.: 13/761,313

(22) Filed: Feb. 7, 2013

Related U.S. Application Data
(60) Provisional application No. 61/602,431, filed on Feb. 23, 2012.

(51) Int. Cl. G06Q 20/40

(52) U.S. Cl. CPC G06Q 20/40145
USPC 705/67; 705/44; 705/71

(57) ABSTRACT

When two parties of a cyberspace transaction register their identity attributes under a CITA system each party is assigned a unique, encrypted and digitally signed identity token. When the consuming party seeks access too, or payment for, cyberspace services, the providing party submits their identity token to the consuming party. The consuming party creates a request token, containing both the consumers' and the providers' identity tokens, and the transaction related information, to the CITA system. The CITA system validates the identity tokens and either creates a payment confirmation token by processing the payment request, or creates an access confirmation token by dynamically defining the minimal consumer identity attributes required to gain access to the provider's service. The confirmation token is encrypted and digitally signed and returned to the consumer, and then forwarded to the provider to complete the transaction without either party openly exchanging personal identity attributes.

### CROSS REFERENCE TO RELATED APPLICATIONS

This patent application is related to Provisional Patent Application No. 61/602,431—Cyberspace Identification Trust Authority Method, Non-Provisional patent application Ser. No. 13/744,369—Cyberspace Trusted Identity (CTI) Module, and Trademark Application #85552808, all herein incorporated by reference. A Notice of Allowance (NOA) for Trademark Application #85552808 was issued by the USPTO on Oct. 2, 2012 and CITA is now a registered trademark of REV Incorporated.

A third party system; the Cyberspace Identification Trust Authority (CITA) system, and a method comprising PKI, data encryption, digital signatures, multi-modal biometric identification, and the creation of dynamic digital identity tokens, provides for the establishment of trusted identities between two cyberspace parties and a mechanism for establishing secure communications and automated electronic payments between said parties without openly disclosing privacy information.

### STATEMENT REGARDING FEDERALLY SPONSORED RESEARCH OR DEVELOPMENT

N/A

### BACKGROUND OF INVENTION

Today's world faces an abundance of increasingly sophisticated attacks against personal, sensitive, financial, and confidential information held by cyberspace users. The cases of identity theft and fraudulent transactions within the cyberspace electronic commerce, retail, and other business segments; coupled with attacks and invasion of cyberspace systems providing access to web portals or support to critical infrastructure services, such as gas, electric, or water utilities, are increasingly common. As additional commercial and government cyberspace services providers become available to cyberspace consumers, both in the retail environment and the on-line environment, the amount of sensitive information transmitted between two cyberspace parties will only increase, as will the increased probability of financial and personal loss associated with identity theft, data theft, and privacy breaches.

In today's electronic commerce world a cyberspace consumer is often required to provide sensitive privacy information in order to gain access to a service provider's service or make payments for services provided. For example, a consumer is often required to provide a user name and password or PIN to gain access to an on-line system, or provide a driver license to gain access to an age-restricted facility. As well, consumers are often required to provide sensitive financial account information, e.g., providing a credit card to be processed by a local retailer for services rendered or providing a financial account number to make payments for an order placed on-line. Unfortunately, this sensitive information is not accurately safeguarded once the information is provided to the intended Service Provider.

The current systems and methodologies in place today to protect; consumers, service providers, and financial institutions are unfortunately fraught with numerous opportunities for identity theft and fraudulent transactions, the cost of which is ultimately transferred to the consumer. Financial institutions recovery their loss through increased late fees and over-limit fees and service providers recover the loss of profit from fraudulent transactions or the cost of doing business in the e-commerce world through the increased cost of goods/services provided. In 2010 the on-line revenue loss to service providers due to fraudulent transactions alone was estimated at $2.78.¹ ¹ Cybersource, 12^{th} Annual Online Fraud Report, 2011 Online Fraud Report, Web: www.cybesource.com.

This increased debt to consumers is brought about by a current system that fails to protect consumer's financial information accurately and securely. While the total amount of losses, both financial and personal, due to online fraud and identity theft are difficult to measure, the problem is genuine and increasing on an annual basis². In addition, a service provider's retail environment and/or their internet site often does not always provide a secure environment for consumers to request or utilize the provider's services, as consumers have limited ability to manage or protect their personal information once it is released to a service provider. As a result, the consumer is often forced to make a trade-off, between the increased risk of identity theft and the desire to easily and comfortably utilize a service they desire. Likewise, service providers must often trade the increased risk of fraud against the ability to expand their service offering in an online environment. The 2009 Internet Crime Report states, “From Jan. 1, 2009, through Dec. 31, 2009, the Internet Crime Complaint Center (IC3) Web site received 336,655 complaint submissions. This was a 22.3% increase as compared to 2008. The total dollar loss from all referred cases was $559.7 million, up from $264.6 million in 2008. “2009 Internet Crime Report” Internet Crime Complaint Center IC3, 12 Mar. 2010, p 14, Web: 2 Jun. 2010, http://www.ic3.gov/media/annualreport/2009_IC3 Report.pdfOver 10 million Americans are victims of identity theft each year—“The Department of Justice's Efforts to Combat Identity Theft”—U S Department of Justice, Office of the Inspector General, March 2010 Web: 2 Jun. 2010 http://www.justice.gov/oig/reports/plus/a1021.pdf.A Federal Trade Commission survey found that victims of identity theft can spend more than 130 hours reconstructing their identities (e g, credit rating, bank accounts, reputation, etc) following an identity crime—“2006 Identity Theft Survey Report” Federal Trade Commission November 2007, p6, Web: 2 Jun. 2010 http://www.ftc.gov/os/2007/11/SynovateFinalReportIDTheft2006.pdf.

Furthermore, consumers have a limited ability to utilize secure identities across multiple service providers because many of the web portals offered through service providers do not utilize a common enterprise security framework. Instead, the consumer is faced with the increasing responsibility, complexity, and inconvenience associated with managing multiple user accounts and passwords, and other identity credentials required to obtain or conduct services online and across dissimilar service providers.

As a result, many consumers practice unsafe cyberspace habits to manage their extensive list of on-line identities, to include; using poorly established passwords that are easily detected through common dictionary attacks, manually recording identity credentials that can be easily comprised if not adequately safeguarded, reusing the same identity credential across multiple service providers, or practicing unsafe browser habits, e.g., cookies that are not properly deleted, to maintain their online identity credentials. A 2007 study of more than a half million cyberspace users found that; about 1.5% of all Yahoo! users forgot their password each month; the average cyberspace user has 6.5 passwords, which are reused across 3.9 different cyberspace web portal sites; the average cyberspace user has 25 accounts that require

passwords and types on average 8 passwords per day; and that 0.4% of the cyberspace population fall victims to phishing attacks each year³. ³ A Large Scale Study of Web Password Habits—Dinei Florensio and Cormac Haley—Microsoft Research, 2007. http://www2007.org/papers/paper620.pdf

In today's corporate world where access to secure web sites requires additional layers of security the use of RSA tokens is often employed. RSA Tokens provide an extra layer of security through two-factor authentication. i.e., the user still provides their password and also provides a PIN code as displayed on the RSA token. Under these solutions the user not only has to still remember their assigned user name and password, they also have to remember to have in their procession their RSA token in order to supply the random PIN key that is periodically updated on the token in order to gain access to the site. Thus, while the benefits of the RSA token approach enhance the level of security it does so at increased cost of managing RSA tokens, which are still susceptible to being lost or stolen, and the increased level of inconvenience to the consumer who is required to have the RSA token in their procession at all times.

Finally, the collection of consumer's identity-related information across multiple service providers, coupled with the sharing of personal information through the wonder of the social media phenomenon, only serves to increase the likelihood for data compromise and privacy breeches. Together, these vulnerabilities of the current environment leads to further opportunities of cybercrime as on-line hackers continue to penetrate on-line service providers and end consumers to illegally obtain user account and password information.

The current trend in the credit/debit card industry to address identity theft places the emphasis on the use of Near Field Communication (NFC) technology. This technological approach employs the use of “smart credit cards” that utilize smart card technology with an embedded computer chip supporting the ability to transmit payment information from the physical credit card to a payment terminal using radio frequency (RF) capabilities. NFC standards cover communications protocols and data exchange formats, and are based on existing radio-frequency identification (RFID) standards including ISO/IEC 14443. Thus, a Consumer is no longer required to physically provide the actual card to the Service Provider (thereby reducing the probability of unknowingly releasing their financial account information to a potential identity theft criminal) as the financial account information is automatically transferred to the payment terminal through RF mechanisms as the Consumer passes the card over the payment terminal's RF reader, or in some cases, is in close proximity to a payment terminal that incorporates NFC technology. The smart phone industry seems to be following this trend as the availability of NFC technology within smart phones is also on the rise. The Android OS currently supports NFC capabilities and Apple and RIM will be soon be incorporating NFC capabilities into their latest smart phone offerings.

Why is the use of NFC technology the wrong approach? First, the deployment of NFC technology to many Service Providers may be cost prohibitive as it requires the Service Provider to have a payment terminal that can accept an NFC-based transaction. This limits the availability of Service Provider locations that will even support NFC technology. On top of that, the approach is based solely on the retail point-of-sale transaction, where the Consumer presents the physical card to the Service Provider. NFC does nothing to address on-line cybercrimes where the Consumer unknowing provides financial account information to an untrustworthy web site where the account information can be readily available for the cybercrime professional to obtain. Secondly, and most importantly, the NFC capability does not protect against Man-in-the-Middle attacks where a portable RF reader can be utilised by a cybercrime professional to obtain the financial account information as it is passed from the Consumer to the Service Provider. While the communication range of NFC is limited to a few centimeters, NFC alone does not ensure secure communications. Thus, a cybercriminal's eavesdropping device only has to be in the same proximity of the payment terminal reader as the data exchange is not protected through PKI and/or data encryption methodologies. While industry has recommended that NFC incorporates data encryption and PKI methodologies the current ISO standard, upon which NFC is based, does not support these capabilities. An alternative approach to NFC vulnerabilities is to employ these data security capabilities at the application layer, where cryptographic protocols, e.g., secure socket layer (SSL) can be utilized to establish a secure channel, but the approach proves to be unfeasible and cost prohibitive due to the complexity of establishing a mutually authenticated connection. Mutual authentication requires both the sending party and the receiving party to mutually authenticate each other through the exchange of digital certificates and by far provides the highest level of trusted and secure communications. But, implementing such an approach would require both the payment terminal and the physical card to store digital certificates for every possible payment transaction they will ever encounter, which is simply not possible.

A fundamental problem with the current e-commerce environment is the payment vehicle itself; the credit/debit card. Why does a consumer need to have in his/her possession a physical card that is susceptible to being lost or stolen? This man-made device is mass produced by financial institutions around the world and issued to millions of card holders on an annual basis. Consequently, the vulnerability of gaining access to a Consumer's financial account information is only amplified, as little or no safeguards can be added to the physical card in a cost efficient manner to safeguard the financial account information readily displayed on the card. Prior attempts to safeguard the physical card have included the use of a digital photo of the card holder, which is intended to be verified by the Service Provider upon accepting the card. While the solution (when utilized as a standard norm of point-of-sale business practices) can deter the use of stolen cards, it does nothing to address on-line cybercriminals using the same level of financial account information from stolen cards. Personal Identification Numbers (PIN) have also been used to safeguard the use credit/debit cards for years, and with some level of success, but the cost of manufacturing these cards and the administrative burden of managing PINs is pushed back upon the Consumer. In addition, successful hacking methodologies to gain access to consumer PIN information and/or reproducing counterfeit cards have also established vulnerabilities under this approach. The introduction of the Card Security Code (CSC), also referred to as the Card Verification Data (CVD), Card Verification Value (CVV or CVV2), Card Verification Value Code (CVVC), Card Verification Code (CVC or CVC2), Verification Code (V-Code or V Code), or Card Code Verification (CCV), was an attempt to address on-line fraud, but while the capability has proven effective in reducing fraudulent transaction rates the approach is still susceptible to being compromised as the code itself is still readily available from the physical card and in many cases can be obtained through the hacking of on-line financial institutions and/or Service Providers that maintain the information in a less than secure manner.

Alternative solutions seeking to address the vulnerabilities of present day card technology and to overcome the fraudulent attempts of using stolen and/or counterfeited cards relies upon the use of smartcard technology combined with biometrics and/or a PIN. Under these solutions the identity of a Consumer is confirmed and a biometric sample is captured from the Consumer and physically stored on the smartcard. In order to use the card the Consumer must authenticate their identity by providing a live biometric sample, which can then be compared to the biometric sample stored on the card. If higher level of authentication is required the user must also present the associated card PIN. If the biometric samples (and PIN) are matched the Consumer is confirmed to be the valid owner of the card and the use of the card can be approved. While various biometric modalities. i.e., fingerprint, iris, face, etc., have been deployed under these proposed solutions the approach itself still presents vulnerabilities. First, because the biometric samples and PIN are electronically stored on the card they are susceptible to being reproduced if not adequately safeguarded through PKI and data encryption methodologies. Second, because the verification matching process can be performed through an applet stored within the card chip, which can be altered if not adequately safeguarded, the verification approach is independent and outside the direct control of the Service Provider attempting to confirm the identity of the card holder. Lastly, if the control of the verification matching process is assigned to the Service Provider the solution becomes cost prohibitive as all service providers will now have to support and integrate additional hardware/software capabilities into their present day POS systems to support the use of these smart cards. Examples of these approaches to overcoming physical card vulnerabilities and using biometric identification/PIN technology coupled with a physical card are described under the following patents; U.S. Pat. No. 4,821,118 (Lafreniere); U.S. Pat. No. 4,993,068 (Piosenka et al.); U.S. Pat. No. 4,995,086 (Lilley et al.); U.S. Pat. No. 5,054,089 (Uchida et al.); U.S. Pat. No. 5,095,194 (Barbanell); U.S. Pat. No. 5,109,427 (Yang); U.S. Pat. No. 5,109,428 (Igaki et al.); U.S. Pat. No. 5,144,680 (Kobayashi); U.S. Pat. No. 5,146,102 (Higuchi et al.); U.S. Pat. No. 5,180,901 (Hirainatsu); U.S. Pat. No. 5,210,588 (Lee); U.S. Pat. No. 5,210,797 (Usui et al.); U.S. Pat. No. 5,222,152 (Fishbine et al.); U.S. Pat. No. 5,280,527 (Gullman et al.); U.S. Pat. No. 5,230,025 (Fishbine et al.); U.S. Pat. No. 5,241,606 (Horie); U.S. Pat. No. 5,265,162 (Bush et al.); U.S. Pat. No. 5,321,242 (Heath, Jr.); U.S. Pat. No. 5,325,442 (Knapp); and U.S. Pat. No. 5,351,303 (Willmore), which are incorporated by reference in this invention.

The example patents cited above utilize biometric technology in combination with smart cards and/or common every day credit/debit card technology. Thus, the Consumer is still required to carry and present a physical card in order to authenticate their identity and/or ownership of the card. While these approaches still carry the burden on the Consumer to physically possess the card in order to carry out a service transaction successfully, they also carry the additional burden of being cost prohibitive when the cost of the card technology (a PIN and/or biometric based smartcard cost on the order of $5), coupled with the cost of the enterprise infrastructure required to support such an approach (POS systems require the ability to read and interpret smartcard and possibly the ability to capture biometric samples) are taken into consideration. With over 100M current card holders and over 5M POS terminals operational the cost of deploying such a solution (and making it readily available to Consumers everywhere) quickly exceeds the current annual estimates of revenue loss due to fraudulent transactions. As with the above cited examples, these additional costs burdens would ultimately be passed on to the Consumer through higher fees associated with the use of these approaches.

The industry has also explored the use of biometrics through “token-less” based approaches to addressing fraudulent transactions and identity theft, as evidenced under U.S. Pat. No. 7,536,352 B2 (Lapsley et al.); U.S. Pat. Appl. 20070291996 (Hoffman et al.); and U.S. Pat. Appl. 20020019811 (Lapsley et al.). Under these solutions the Consumer registers with a third party system to enroll a sample biometric under an assigned unique PIN. The Consumer's registration process also requires the Consumer to identify a financial account upon which funds are draw to make payment on approved service transactions. Service Providers using this approach are also required to register with the third party system and under some of these proposed inventions assign a unique PIN to the Service Provider as well, in addition to requiring the Service Provider to designate a financial account to receive Consumer payments. Under these “token-less” based approaches the Consumer and Service Provider complete payment for a service transaction when the Consumer uses an electronic device at the POS terminal to enter their PIN and capture a live biometric sample, which is then submitted (together with other information relating to the transaction, i.e., the Service Provider's PIN, the amount of the service transaction, etc.) to the third party system for approval. The third party system in turn compares the Consumer's live biometric sample to their registered biometric sample to authenticate their identity and in so doing initiates completion of the financial transaction by transferring funds from the Consumer's account to the Service Provider's account.

While these proposed inventions successfully remove the credit/debit card “token” from the equation they still exhibit limitations and vulnerabilities disclosed under the previously addressed solutions. For example, it remains the burden of the Consumer to always remember their PIN, as without it they are unable to even initiate a transaction. As well, the solutions require access to an electronic device at the POS terminal that supports the ability to communicate with a third party system, capture a Consumer's PIN, and capture a Consumer's biometric sample. As stated earlier placing such a device at POS terminal locations would be cost prohibitive and ultimately passed on to the Consumer to burden. But most importantly, none of the cited examples address the need to safeguard the information exchanged between the Service Provider, Consumer, and the third party system. As the use of PKI methodologies and data encryption technology are not incorporated into these inventions the proposed solutions still suffer the vulnerability of man-in-the-middle attacks and accessibility to Consumer privacy information by cybercriminals without these safeguards in place. Lastly, the solutions rely upon a third party system that can support real-time biometric identification matching capabilities in order to complete the transaction in a timely manner. Such a solution could also be cost prohibitive to implement (considering the need for the POS devices to support such a capability and the additional network bandwidth capacity required to transmit biometric records between the Consumer/Service Provider and the third party system), outside the fact that delayed service capabilities with transmitting these larger amounts of data and availability of the solution would result in further delays with completing the POS transaction.

Lastly, the e-commerce world has struggled with the ability to limit the amount of consumer privacy information required to be provided by Consumers to access Service Provider services mainly because the Service Providers want access to this level of information. One driving reason for this is the marketing demand by Service Providers to utilize data analytic services to determine the most profitable profile of their e-commerce clientele. For example, many of today's retail environments utilize marketing research capabilities based upon data analytic services to determine what is working well in their e-commerce solution, i.e., attracting potential customer's attention, and what is not working well. The data analytic services provided to retailers in today's e-commerce world gather vast amounts of detailed information on consumers shopping and buying habits, and can provide the retailer with the lowest levels of details on the average consumer, to include; what they searched for on their web page, how long they spent on their web site, what they purchased, how much they spent, what was their purchase history over the last year, what their email address is for direct marketing campaigns, etc. Service Providers do not want to relinquish this level of marketing data over privacy concerns as the data in many cases directly correlates to increased profitability rates. As a result, the Consumer often loses out in the argument of increased profitability through better/direct marketing campaigns versus the consumer's privacy concerns.

As a result of these existing vulnerabilities and limitations in the cyberspace world there is a need for a new system and methodology that supports industry standard interfaces and data formats while incorporating PKI, data encryption, digital signatures, and multi-modal biometric identification capabilities all from a Consumer's personal electronic device. Under such a solution a Consumer can freely access on-line services without the need to maintain and manage multiple user account IDs and passwords, as the system automatically authenticates the Consumer's identity and dynamically provides the appropriate Consumer identification attributes to the Service Provider without divulging additional Consumer personal information that is not directly related to, or required for the service transaction to be completed successfully. In addition, the need for a Consumer to physically carry a credit/debit card, in order to successfully complete payment for a service transaction, no longer exists. As well, under this invention the Consumer is no longer required to remember a unique PIN, user account name or password, in order to successfully complete a transaction. Furthermore, this invention does not require a Service Provider to purchase specialized hardware that supports the ability to accurately and efficiently establish trusted identities between a Consumer and a Service Provider, as the invention can support and utilize many of the POS peripheral devices found in the present day retail environments.

As such, the benefits of the innovative approach presented herein for providing trusted cyberspace identities and the increased security of electronic payment transactions far outweighs the significant list of limitations present in today's Internet and retail environments. By introducing a new innovative approach, which incorporates PKI, data encryption, and multi-modal biometric identification technology, to address these vulnerabilities and limitations the prevalent cases of fraud and privacy infringements, coupled with the increased inefficiencies placed upon the Consumer and Service Provider to authenticate identities, can be reduced and/or eliminated. In addition, the ability for Consumers and Service Providers to mutually trust each others' identities, together with the ability to make electronic payments easily and securely, will help to increase the economic efficiencies of Service Providers as more Consumers establish trust in using their services, as well as reduce the cost of goods/services provided to the Consumer, which ultimately benefits the Consumer who has suffered the burden of paying for the limitations in the current cyberspace environment.

Accordingly, an objective of this invention is to provide a new system; the Cyberspace Identification Trust Authority (CITA) system, and method to conduct cyberspace transactions through the use of established and trusted digital identity tokens, coupled with multi-modal biometric authentication, and without the need for Service Providers or Consumers to openly divulge and exchange privacy and/or financial information.

Another objective of the invention is to establish a trusted Third Party system that will maintain a registry of digital identity tokens for Service Provider and Consumer identities to be authenticated, thus eliminating the need for Consumers to manage and maintain multiple identity attributes for conducting cyberspace transactions.

Another objective of the invention is for said Third Party system to utilize multi-modal biometric identification as a means to establish the unique identity of Service Providers and Consumers, thus eliminating the chance of Service Providers and/or Consumers establishing multiple fraudulent identities under which to conduct cyberspace transactions.

Another objective of the invention is for said Third Party system to utilize credit checking services to authenticate financial account holdings of Service Providers and Consumers, thus ensuring that Consumer and Service Provider payments are only processed against valid financial accounts held by the true account holder.

Another objective of the invention is to establish a new industry standard and methodology for authenticating personal identity attributes, based upon “zeligmetrics”. The term is adopted from the 1984 Woody Allen movie “Zelig”, about a curiously nondescript enigma (Leonard Zelig) who is discovered for his remarkable ability to transform himself to resemble anyone in his immediate environment. The Merriam-Webster Dictionary defines the term “zelig” as; “A Chameleon like person who is unusually ubiquitous”. Thus, a zelig has multiple discrete identity attributes, the combinations of which are defined as “zeligmetrics”. The use of zeligmetrics under the present invention provides the ability for Consumers to operate with a level of anonymity and pseudonymity, and a mechanism to safeguard personal identity attributes and ensure only those attributes required to complete a cyberspace transaction are exchanged between two cyberspace parties. Much like the chameleon, who has the ability to alter their identity attributes in order to blend into their immediate surroundings as a form of protection, Consumers desire these same levels of protection when interacting with Service Providers in cyberspace. For example, access to a nightclub typically requires a Consumer to present a driver's license where their age can be verified to be over 21, but providing this man-made token also presents the nightclub with additional information about the Consumer, to include their name, address, and date of birth, a photo, etc. All that is really required to grant access to the club is confirmation that the individual is over 21, but under this example the Consumer is required to divulge additional personal information attributes in order to gain accessibility to the requested service.

Another objective of the invention is for said Third party system to dynamically create digital identity tokens containing zeligmetric tags to be used by Consumers to gain access to Service Provider services. Said tokens will only contain those Consumer personal identity attributes required to successfully gain access to the Service Providers service, thus the need to exchange personal information not directly related to the transaction undertaken is eliminated.

Another objective of the invention is to establish a new industry standard protocol for authenticating identity attributes, based upon the “Validation of Light Transfer Zeligmetrics” (VOLTZ) protocol, which supports the structured exchange of digital identity tokens comprising zeligmetric identity tags linked to a CITA Digital Identity.

Another objective of the invention is for said Third Party system to support the processing of electronic payment transactions on behalf of the Service Provider and Consumer, thus eliminating the need for either party to openly exchange financial account information.

Another objective of the invention is to utilize a Security Module; the Cyberspace Trusted Identity (CTI) Module, on an electronic device that is only accessible through multi-modal biometric authentication and upon which, Consumers can securely store their CITA Digital Identity tokens.

Another objective of the invention is to provide CITA Third party system software applications that are certified through said Third Party system and support trusted and secure interfaces with said Security Module operating on Consumer's electronic devices.

Another objective of the invention is for said software applications operating on Consumer electronic devices to support the automated capture and processing of CITA Digital Identity tokens provided by Service Providers, thus improving the overall efficiency of processing cyberspace transaction and reducing Service Provider and Consumer wait time.

Another objective of the invention is for the CITA Third party system and software applications to support PKI key management, digital signature validation, and data encryption services to support the establishment of mutually authenticated and secured communication links between Service Providers and Consumers and the exchange of encrypted, and digitally signed data packets to ensure the privacy and integrity of Service Provider' and Consumer' personal information.

Another objective of the invention is for said CITA Third party system and software applications to provide for the secure storage of Digital Identity tokens that can be re-used by Consumers when requesting repeated access to Service Provider services, thus eliminating the need for said Third Party system to re-create dynamic digital identity tokens for repeated service requests thereby reducing latency delays in processing cyberspace transactions.

Another objective of the invention is to utilize existing hardware components already available within retail and on-line environments in order to support Service Providers easy and cost effective migration to the new system and method and to reduce cost burdens that would ultimately be placed upon the Consumer.

Another objective of the invention is to eliminate the need for Consumers to provide a written signature to confirm payment of cyberspace transactions. This objective reduces the chance of a Consumer's recorded signature being unknowingly obtained for fraudulent purposes.

Another objective of the invention is for the CITA Third party system to provide an on-line registry of registered Service Providers enabling Consumers to easily and efficiently establish trusted digital identity tokens for accessing select Service Provider services. This objective provides for ease of use and enables the Consumer to establish multiple on-line identities with multiple Service Providers all from a single location.

Another objective of the invention is for the CITA Third party system to provide automated marketing reports to registered Service Providers enabling the Service Provider to gain access to marketing metrics they require to improve their profitability rates. This objective serves to satisfy the Service Providers demand for marketing information while protecting the privacy information of the Consumer.

A final objective of the invention is to utilize a Consumer's electronic devices as the means for establishing trusted identities between two parties, thus eliminating the need for Consumers to carry man-made tokens, i.e., ID cards, credit cards, etc. to gain access to services or make payments for services provided. This objective further reduces the cost burden to financial institutions and government agencies for producing and maintaining said man-made tokens, the cost savings of which can ultimately be passed on to the Consumer.

### BRIEF SUMMARY OF THE INVENTION

The invention presented within satisfies the needs addressed above by providing a system and method for the secure processing of cyberspace transactions without the need for the parties undertaking the transaction to openly divulge and/or exchange private information that is not directly related to the transaction. As well, the system and method presented under this invention utilizes security measures, to include; PKI, digital signatures, data encryption, and multi-modal biometric identification to safeguard and protect the privacy and integrity of information exchanged between the two parties conducting the cyberspace transaction.

The system is comprised of three primary components; (1) a Third Party System—the Cyberspace Identification Trust Authority (CITA) System, which provides the central processing of CITA service transactions and interfaces with a network of financial institutions to support electronic e-commerce transaction processing capabilities, (2) a network of cyberspace consumers, which utilize the services provided by the CITA to gain access too, and/or make payment for services provided by cyberspace service providers using a Cyberspace Trusted Identity Module (CTI-Module) enabled electronic device, and (3) a network of cyberspace service providers, which could include an on-line web portal or a retail establishment where various services are provided to cyberspace consumers. All components are interconnected via the internet, or an intranet.

The method is comprised of three basis services, as performed through the CITA; (1) a Registration service, (2) a Request Access service, and (3) a Request Payment service. In order to use the services offered through the CITA both parties of a cyberspace transaction, i.e., the consumer and the service provider, must register an account with the CITA.

Service providers register an account with the CITA by accessing the CITA web portal and downloading a CITA software application to their electronic device. The downloaded software application includes a one-time CITA registration Public Key that is used to securely transmit registration information between the service provider and the CITA. The CITA registration software application guides the service provider through the registration process and supports the capturing of service provider unique identity attributes, which may include, but is not limited to; personal information, biometric samples, financial account information, the type of services to be provided, and the identity attributes required of consumers to access or obtain the services. The registration process also includes the establishment of unique service provider PKI keys to support data encryption operations, digital signature operations, and the establishment of mutually authenticated communication links between two cyberspace parties. The service provider PKI keys can be created through the service provider's enterprise PKI key management security platform, e.g., a hardware security module (HSM) or a security certificate server, or obtained through the service provider's CTI Module enabled electronic device, which contains embedded PKI keys. The service provider's registration information is encrypted and digitally signed and submitted to the CITA for processing. Upon receipt the CITA system verifies the integrity of the registration packet submitted by the service provider, which may include establishing the unique identity of the service provider using multi-modal biometric identification technology and/or validation checks against the submitted financial and personal information. Upon establishing a unique identity for the service provider the CITA assigns the service provider a unique digital identity token, which is securely stored within the CITA central repository, returned to the service provider, and securely stored on their CTI Module enabled electronic device, or on their designated security server platform.

Consumers must have a CTI Module enabled electronic device in order to register with the CITA. Consumers register an account with the CITA by accessing the CITA web portal and downloading the CITA software application to their electronic device. The downloaded software application interfaces directly with the CTI Module on the consumer's electronic device and includes a one-time CITA registration Public Key that is used to securely transmit registration information between the consumer and the CITA. The CITA registration software application guides the consumer through the registration process and supports the capturing of consumer information, which may include, but is not limited to; personal identity information, biometric samples, financial account information, and the type of services to be requested of cyberspace service providers, e.g., Request Access services or Request Payment services. The registration process also includes the establishment of unique consumer PKI keys, which are obtained from the consumer's CTI Module coupled with their electronic device, and used to support data encryption operations, digital signature operations, and the establishment of mutually authenticated communications links between two cyberspace parties. The consumer's registration information is encrypted and digitally signed and submitted to the CITA for processing. Upon receipt the CITA system verifies the integrity of the registration packet submitted by the consumer, which may include using multi-modal biometric identification technology and/or validation checks against the submitted financial and personal information to establish the consumer's unique identity. Upon establishing a unique identity the CITA assigns the consumer a unique digital identity token, which is securely stored within the CITA central repository, returned to the consumer, and securely stored on the CTI Module coupled on their electronic device. This registration process also initializes and locks the consumer's CTI Module on their electronic device, which can only be un-locked and accessed through multi-modal biometric identification capabilities, to safeguard the information stored on the CTI Module. Effectively, the consumer's identity is established and trusted by the CITA system and the consumer's electronic device is now permanently linked to the established and trusted cyberspace identity.

This completes the CITA registration process for the service provider and the consumer with each party establishing unique and trusted identities on the CITA system and each party receiving unique digital identity tokens, as assigned by the CITA system, which are subsequently used for processing CITA Request Access and/or Request Payment service transactions. These subsequent CITA transactions are initiated by cyberspace consumers, using their CITA software application on their electronic device, when requesting access to a cyberspace service provider's web portal (in lieu of providing a user ID and password) or a retail establishment (in lieu of providing a man-made token, i.e., driver license, passport, etc.), or when a cyberspace consumer request payment for services provided (in lieu of providing cash, a credit card, or financial account information).

In response to a consumer requesting access to a cyberspace service the service provider presents a CITA Request Access token to the consumer, which incorporates the service provider's CITA digital identity token and is encrypted and digitally signed by the service provider so only the CITA can authenticate and interpret the contents.

In response to this action the consumer captures the service provider's Request Access token using their CITA software application, coupled with their CTI Module, on their electronic device. The method of capture can be electronic, i.e., passing of an electronic token via web pages or other means of electronic communications, or manual, i.e., scanning a barcode image containing the service provider's Request Access token. Capturing of the service provider's Request Access token automatically requires the consumer to biometrically authenticate their identity to the CTI Module of their electronic device, thereby unlocking the CTI Module and gaining access to their CITA digital identity token stored on the module. Once the service provider's Request Access token is captured, and the consumer's identity is authenticated to their CTI Module, a consumer Request Access token is created, which incorporates the service provider's Request Access token and the consumer's Digital Identity token. The consumer's Request Access token is encrypted and digitally signed by the CTI Module on the consumer's electronic device so only the CITA system can authenticate and interpret the contents. The consumer Request Access token is then securely submitted to the CITA system to approve the access request.

The CITA system in turn validates the digital signature and decrypts the contents of the token submission to validate the integrity and authenticity of the request, to include authenticating the authenticity of the embedded digital identity tokens for both the consumer and service provider. Once authenticated the CITA system dynamically builds a service provider Access Confirmation token, based upon the identity attributes provided by the consumer during their registration process, and those required by the service provider to permit access to the requested service, as defined by the service provider during their registration process. The service provider Access Confirmation token includes only those identity attributes required for the consumer to gain access to the service, i.e., a web portal access request may require a user Id and password or a retail establishment access request may require proof of age. Thus, the process eliminates the need for the consumer to remember the unique identity attributes required to gain access to the service, or the need to provide additional identity attributes not directly related to the service. To secure the transaction the service provider's Access Confirmation token is encrypted and digitally signed by the CITA so only the intended service provider can authenticate and interpret the token contents, thus the consumer does not have the ability to alter the service provider Access Confirmation token contents as a means of establishing a false identity to gain access to the requested service. The service provider Access Confirmation token is then embedded in a consumer Access Confirmation token, which is also encrypted and digitally signed by the CITA, so only the consumer can authenticate and interpret the token contents. The consumer Access Confirmation token is then securely returned to the consumer's CITA application operating on their electronic device.

Upon receipt of the consumer Access Confirmation token from the CITA system, the consumer's CITA software application uses their CTI Module on their electronic device to validate the digital signature and decrypt the Access Confirmation Token, thereby extracting the embedded service provider Access Confirmation token. The service provider Access Confirmation token is then presented to Service Provider to authenticate and confirm access to the requested service.

The Service Provider validates the digital signature of the Access Confirmation token and decrypts the token contents to obtain the consumer's cyberspace identity attributes, which are then validated against the required identity attributes for the consumer to gain access to the requested service. Upon confirmation the consumer is provided access to the requested service. Thus, a consumer requested and gained access to a service provider's cyberspace service without needing to remember or openly divulging any personal information and furthermore, the complete transaction was protected through multi-modal biometric identification, PKI, data encryption, and digital signature operations using a third party system and a CTI Module enabled electronic device to safeguard and protect the information exchanged between the two cyberspace parties.

As the request access protocol described above includes the ability to support the exchange of PKI keys and or digital certificates between the Consumer and the Service Provider the method supports the ability to establish secured communication links between the two cyberspace parties. Thus, a web portal session based initially upon the Hypertext Transfer Protocol (HTTP) could convert to a Hypertext Transfer Protocol Secure (HTTPS) after the exchange of trusted certificates. Likewise, any communication session between two cyberspace parties, i.e., email exchanges, Short Message Service (SMS) text messages, audio/video conferencing, etc. could employ data packet level encryption capabilities and/or point-to-point mutual authentication services to guarantee the privacy and integrity of the communications link.

When a consumer requests payment services through the CITA system the process is handled in a similar fashion as described above. Having registered an account under the CITA system the consumer has already provided financial account information, from which, funds will automatically be drawn to pay for the requested service. Likewise, when a service provider registers an account under the CITA system they also have designated a financial account, which will receive consumer payments for services provided. Accordingly, after completing a service transaction the service provider presents the consumer with a Request Payment token. Typically this is in the form of a cash register receipt for retail establishments, or a web portal “Check Out” page for on-line transactions. Under this invention the Request Payment token is presented as a digital token and contains the service provider's CITA digital identity token and the payment transaction information, i.e., total cost of goods/services purchased.

In response to this action the consumer captures the service provider's Request Payment token using their CITA software application, coupled with their CTI Module, on their electronic device. The method of capture can be electronic, i.e., passing of an electronic token via web pages or other means of electronic communications, or manual, i.e., scanning a barcode image containing the service provider's Request Payment token. Capturing of the service provider's Request Payment token automatically requires the consumer to biometrically authenticate their identity to the CTI Module on their electronic device, thereby unlocking the module and gaining access to their CITA digital identity token stored within. Once the service provider's Request Payment token is captured, and the consumer's identity is authenticated to their CTI Module, a consumer Request Payment token is created by the CITA software application using the CTI Module on their electronic device. The consumer Request Payment token incorporates the service provider's Payment Request token, and includes the consumer's digital identity token, and any additional information required to complete the payment process, e.g., the consumer can select the account from which funds are to be drawn to pay for the service, and/or the consumer may wish to add gratuity to the payment. The consumer's Request Payment token is then encrypted and digitally signed by the Consumer's CTI Module so only the CITA system can authenticate and interpret the token contents. The consumer Request Payment token is then securely submitted to the CITA to approve and process the payment request. Thus, the integrity and privacy of the payment information is safeguarded at all times.

The CITA system in turns validates the digital signature of the consumer's Request Payment token and completes the payment request through standard electronic commerce processing mechanisms to transfer funds between the two designated accounts. Once the payment process is completed the CITA system creates a service provider Payment Confirmation token, which includes a confirmation of the payment made. To secure the transaction the service provider Payment Confirmation token is encrypted and digitally signed by the CITA so only the intended service provider can interpret and authenticate the token contents, thus the consumer does not have the ability to alter the Payment Confirmation token contents as a means of fraudulently confirming payment for the service. The service provider Payment Confirmation token is then embedded in a consumer Payment Confirmation token, which is also encrypted and digitally signed by the CITA, so only the consumer's CTI Module can validate the digital signature and interpret the token content. The consumer Payment Confirmation token is then securely returned to the consumer's CITA application operating on their electronic device.

Upon receipt of the consumer Payment Confirmation token from the CITA system the consumer uses their CITA software application, coupled with their CTI Module, on their electronic device to validate the digital signature and decrypt the Payment Confirmation token content, thereby extracting the embedded service provider Payment Confirmation token. The service provider Payment Confirmation token is then presented to Service Provider to authenticate and confirm successful payment for the services provided.

The Service Provider validates the digital signature of the Payment Confirmation token and decrypts the token contents to obtain the payment confirmation information thereby validating the payment has been completed successfully. Thus, a consumer requested and made payment for a cyberspace service provided by a service provider without openly divulging any financial account information and furthermore, the complete transaction was protected through multi-modal biometric identification, PKI, data encryption, and digital signature operations using a third party system and a CTI Module enabled electronic device to safeguard and protect the information exchanged between the two cyberspace parties.

### BRIEF DESCRIPTION OF THE SEVERAL VIEWS OF THE DRAWING

FIG. 1—Presents the preferred architecture of the Cyberspace Identification Trust Authority (CITA) enterprise system.

FIG. 2—Presents a representative schematic diagram of the preferred embodiment of a CITA application program hosted on an electronic device and interfacing with the Cyberspace Trusted Identity (CTI) Module.

FIG. 3—Presents a listing of example CITA tokens envisioned to be used by the invention to support CITA system transactions and defines the contents and use of each token and how they are exchanged between a Consumer, Service Provider, and the CITA system.

FIG. 4—Presents a diagram depicting the representative CITA workflow processing for a service provider registering for CITA services.

FIG. 5—Presents a diagram depicting the representative CITA processing workflow for a consumer registering for CITA services.

FIG. 6—Presents a diagram depicting the representative CITA processing workflow for establishing trusted identities between two cyberspace parties when a consumer request access to a service provider's service.

FIG. 7—Presents a diagram depicting the representative CITA processing workflow for processing a secure electronic payment between two cyberspace parties when a consumer request payment for a service provider's service.

### DETAILED DESCRIPTION OF THE INVENTION

The components shown in the figures presented within this invention, their connectivity to other components, their functions, and their relationships with other components depicted within are intended to be representative only, and are not intended to limit the implementations of the invention and/or the claims specified under this invention. The order in which components, functions, or processes is presented is representative only, and various implementations approaches may be taken without contradicting and/or violating the spirit and scope of this invention.

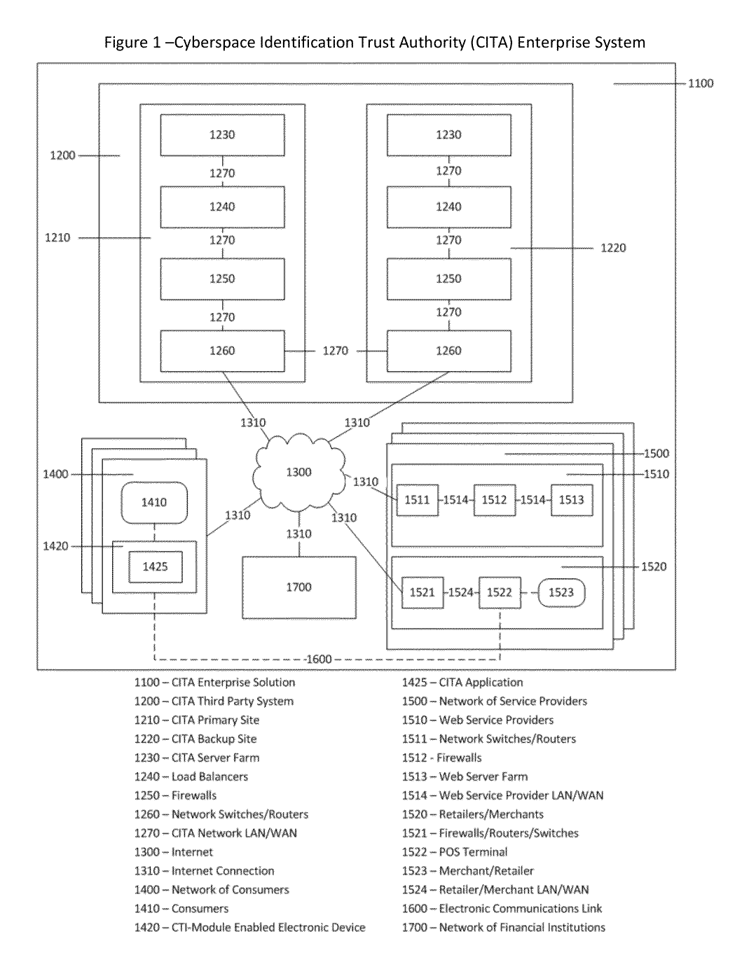

The Cyberspace Identification Trust Authority (CITA) system and method (see FIG. 1) provides a secure computer hardware/software CITA Enterprise Solution [1100] that supports the ability to securely manage and process cyberspace service provider and consumer digital identity tokens using PKI, data encryption, digital signatures, and multi-modal biometric identification methodologies. The CITA enterprise solution is comprised of a CITA Third Party System [1200], a network of Consumers [1400], a network of Service Providers [1500], and a network of Financial Institutions [1700], all interconnected through LAN/WAN connections to the Internet [1300].

The CITA Third Party System [1200] is further comprised of a CITA Primary site [1210] and a CITA Backup site [1220]. Each site contains a fully redundant Server Farm [1230], which provides CITA transaction processing services, to include; Multi-modal Biometric Matching services, Secure Database Storage services, Web Services, E-Commerce payment services, Digital Identity Management services, and services supporting secure storage of PKI keys, data encryption, and digital signatures operations. Each CITA site is further comprised of Load Balancers [1240], Firewalls [1250], and Network Switches/Routers [1260], all interconnected through a CITA Private LAN/WAN [1270].

Services offered under the CITA Third Party system [1200] include, but are not limited to; the ability to mutually authenticate the identity of a Service Provider and Consumer; the ability to create dynamic digital identity tokens on behalf of the consumer, thus supporting the ability for a consumer to easily and efficiently access a service providers' cyberspace services without openly divulging their privacy information; the ability to provide a mechanism for establishing a secure communications channel between a consumer and service provider; the ability to approve, initiate, and complete electronic payments on behalf of a consumer for goods/services purchased from a service provider; and the ability to uniquely identify and/or authenticate the identity of a service provider and/or consumer through multi-modal biometric identification technology.

The CITA Network of Consumers [1400], include individual Consumers [1410] with access to a CTI-Module Enabled Electronic Device [1420]. The consumer's electronic device hosts a CITA Application [1425], and can take any form of a personal computing device, which includes but is not limited to; PCs, Laptops, Tablets, PDAs, Smart phones, etc., with an embedded operating system, user interface, embedded CTI module, and connectivity to the Internet [1310] and using the Internet [1300] to gain access to the CITA Third Party system [1200].

The CITA Network of Service Providers [1500], include Web Service Providers [1510] providing consumer access to a web portal, and Retailers/Merchants [1520] providing goods/services to consumers. Each Web Service Provider [1510] configuration is further comprised of Network Switches/Routers [1511], Firewalls [1512], and Web Servers [1513], all interconnected through a Web Service Provider LAN/WAN [1514]. Each Merchant/Retailer [1520] configuration is further comprised of Network Switches/Routers [1521] and Firewalls [1522] connected through a Retailer/Merchant LAN/WAN [1514], and Merchant/Retailer [1523]. The Web Service Providers [1510] and Retailers/Merchants [1520] connect to the Internet [1300] through an Internet Connection [1310] to gain access to the CITA Third Party system [1200].

Lastly, the Network of Financial Institutions [1700] is comprised of banking and financial payment service systems capable of supporting electronic e-commerce transaction processing. These systems connect to the Internet [1300] through an Internet Connection [1310] to gain access to the CITA Third Party system [1200].

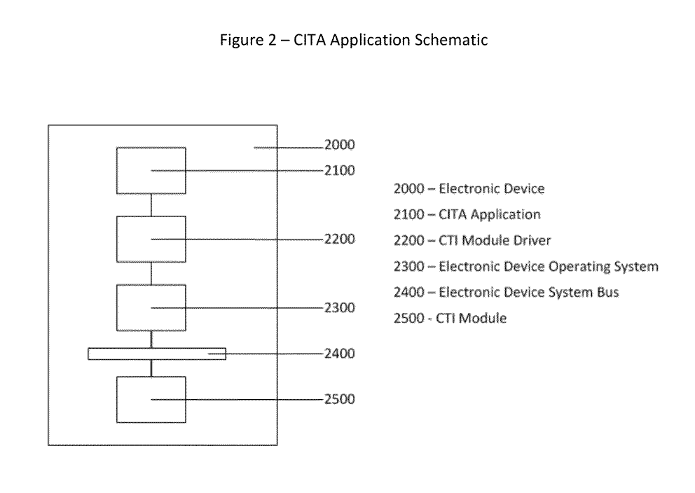

As depicted under FIG. 2, the CITA application [2100] operating on the consumer's Electronic Device [2000] interfaces with a CTI Driver Module [2200], which interfaces with the Electronic device Operating System [2300], and utilizes the Electronic Device System Bus [2400] to interface with the CTI Module [2500]. The CITA application controls the communications with the CITA system, and utilizes the data cryptography services, secure storage mechanisms, and CITA token processing services provided by the CTI Module to manage the secure message processing capabilities required to conduct CITA based transactions.

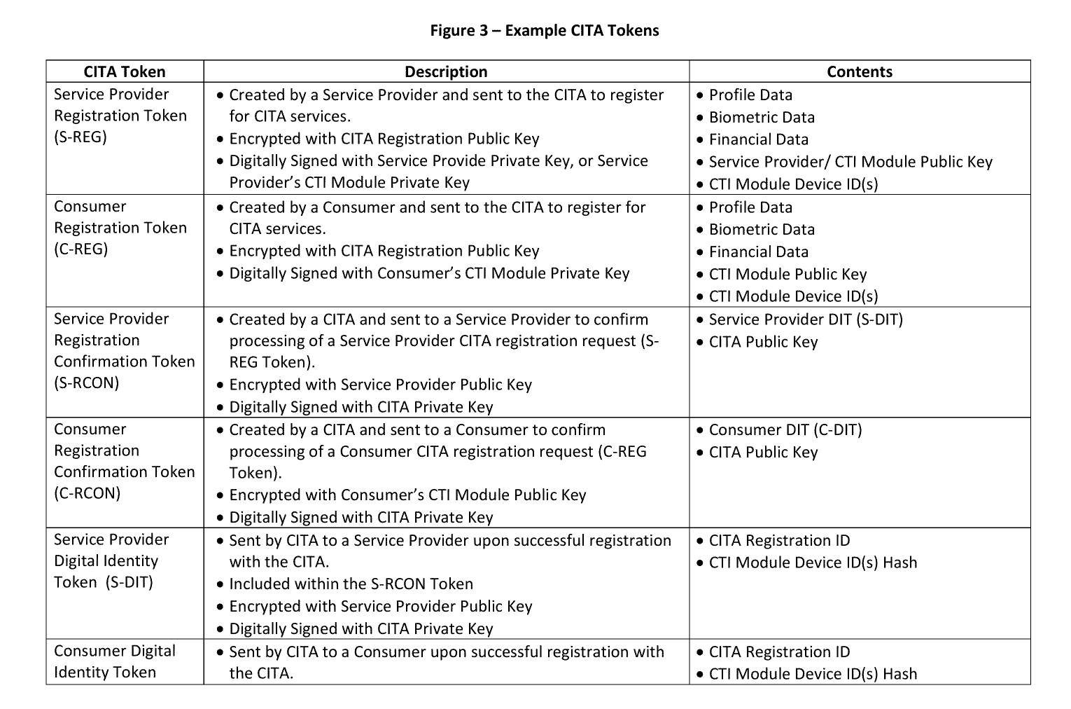

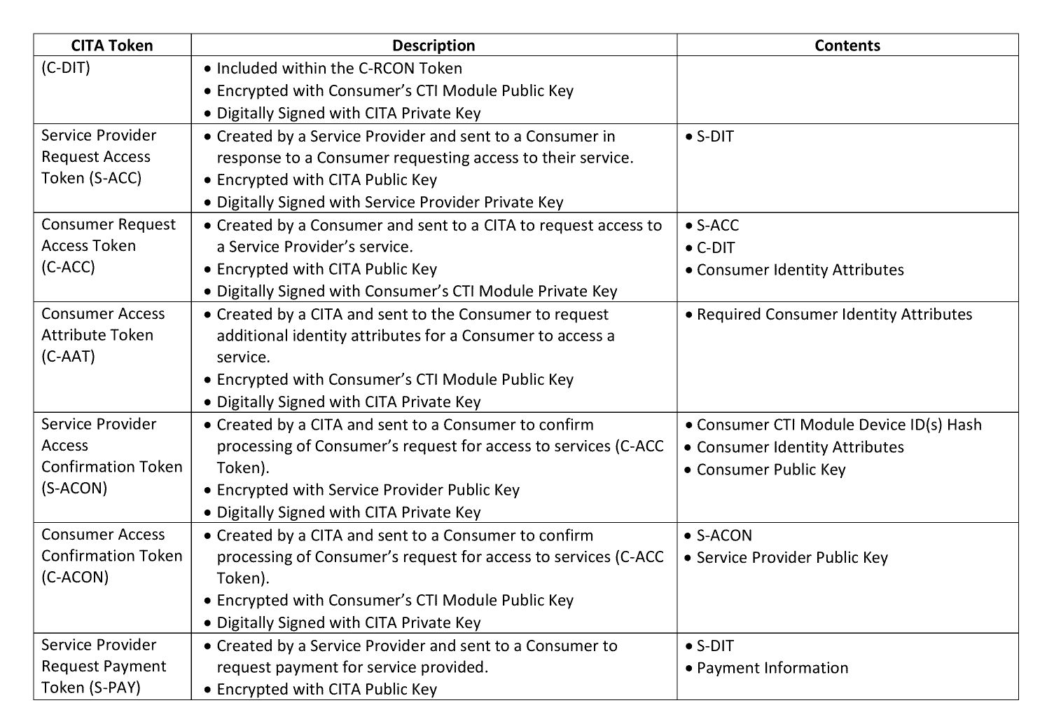

All CITA based transactions are based upon CITA tokens, embedded within CITA transactions. To protect the integrity and privacy of a CITA transaction the transaction content is always encrypted and digitally signed, thus the CTI Module provides the ability to decode a CITA transaction provided by the CITA to extract the transaction data, or encrypt and digitally sign a CITA token to be presented to the CITA system. FIG. 3 defines examples of the types of CITA tokens envisioned to be supported under the present invention and provides a description of their use, content, and how they are passed between a Consumer, Service Provider, and/or the CITA system. Note: The CITA Token definitions of use, their content, and exchange methodologies presented within this invention are representative only, and are not intended to limit the implementations of the invention and/or the claims specified under this invention. As such, various implementations approaches may be taken, to include defining additional token types or formats, without contradicting and/or violating the spirit and scope of this invention.

The establishment of trusted cyberspace identities is performed through the mutual authentication of digital identity tokens, which are assigned to consumers and service providers through the CITA Third Party System. In order to be assigned a CITA digital identity token a consumer/service provider must register with the CITA system, and must have a CTI Module enabled electronic device hosting a CITA software application to support the secure processing a CITA tokens. The CITA software application also supports the ability to capture live biometric samples and subsequent multi-modal biometric matching against registered biometric samples using the CTI Module in order to accurately establish the true identity of each party and the true owner of the electronic device. Thus, when the CTI Module is embedded in an electronic device and the device owner's biometric samples are registered to the CTI Module under the CITA enterprise solution, the device and the owner become trusted identity components of the cyberspace trusted community.

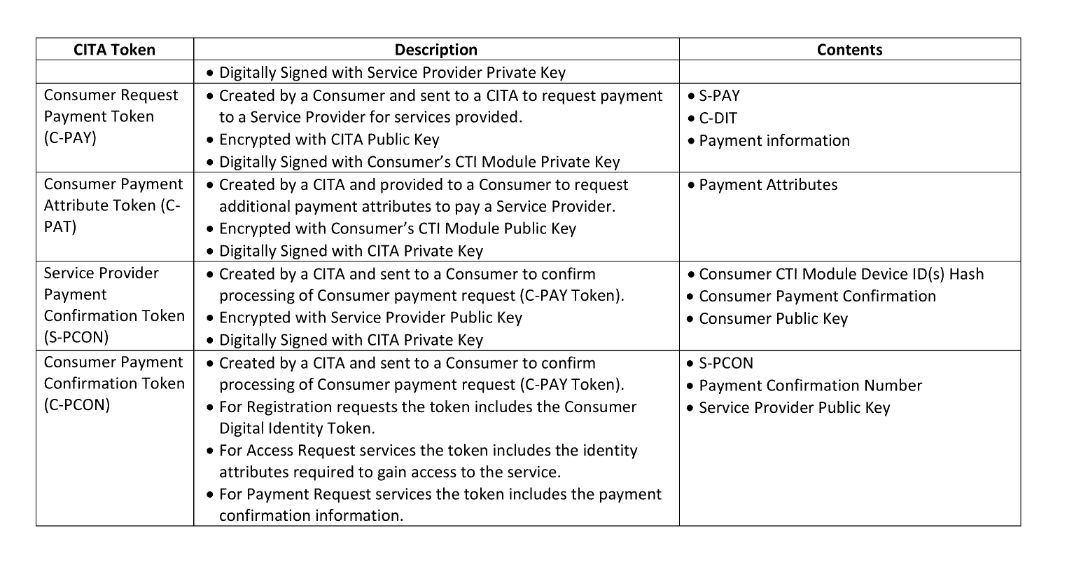

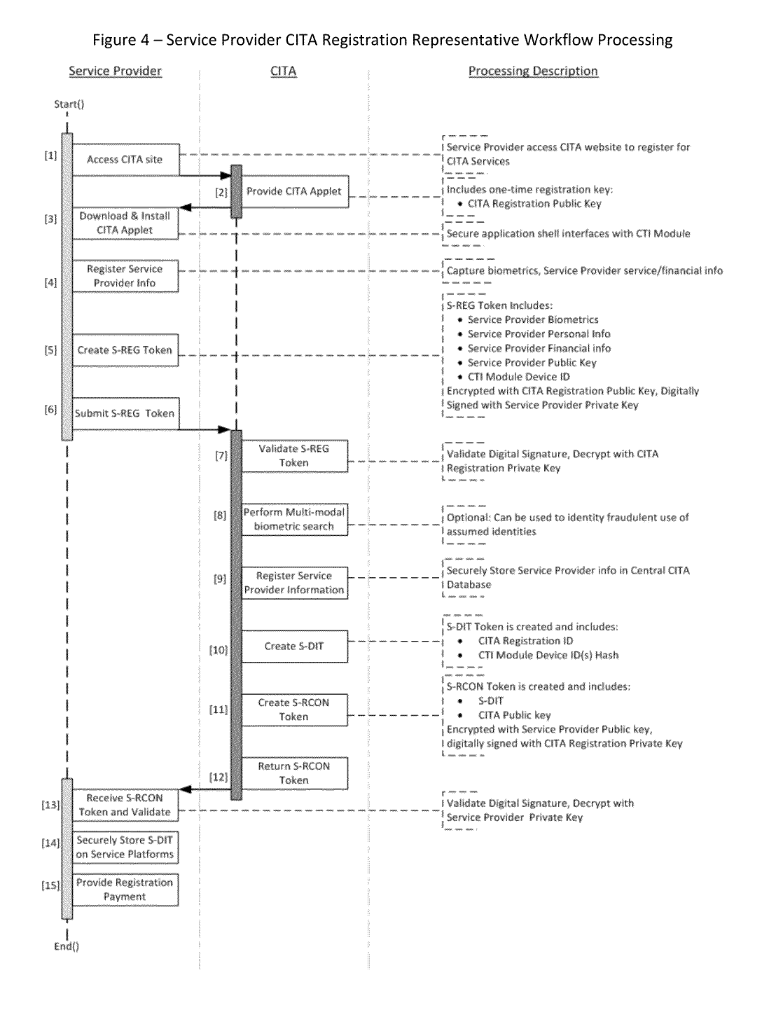

As depicted under FIG. 4, service providers register an account with the CITA system through a secure application operating on their electronic device. In Step [1] of the registration process the service provider accesses the CITA Third Party system web portal to create a new service provider account.

In Step [2] the CITA system provides the service provider with access to the registration software application, which can be downloaded and installed on the service provider's electronic device.

In Step [3] the service provider downloads and installs the registration software application on their electronic device. The downloaded software application includes a one-time CITA Registration Public key, which will subsequently be used for encrypting all subsequent submissions between the service provider and CITA system. In Step [4] the service provider initiates the registration process and the CITA application interfaces with the CTI Module and requires the service provider to capture live biometric samples using their electronic device and supply additional biographic and financial information related to the offered service. This information gathering step also requires the service provider to identify the types of identity attributes required to be provided by consumers to access the service provider's services and/or any financial accounts that will receive payments from consumers for services offered. This action registers the CTI Module to the electronic device and securely maintains the captured information on the CTI Module. Subsequent access to the information will only be provided through multi-modal biometric authentication of the device owner. In Step [5] the registration module creates a Service Provider Registration (S-REG) Token (See description provided under FIG. 3). The S-REG Token contains the services provider's captured biometric samples, personal information, financial information, the CTI Module Device ID, and a copy of the service provider's Public key (obtained from the CTI Module or their Enterprise Security Server). The S-REG Token is encrypted and digitally signed by the CTI Module using the CITA Registration Public Key and the service provider's Private Key (maintained on the CTI Module or the their Enterprise Security Server). In step [6] the encrypted S-REG Token is then securely submitted to the CITA system for processing.

In Step [7] the CITA system validates the digital signature and decrypts token using the CITA Registration Private Key and validates the S-REG Token contents. In Step [8], under one instance of the invention, the CITA system may perform a multi-modal biometric search of the central CITA biometric repository using the registered biometric samples in order to detect and identify a service provider attempting to provide services under multiple assumed identities. In Step [9] the CITA system assigns a unique CITA Registration ID and re-encrypts the service provider's information and stores the information in the central CITA repository. In Step [10] the CITA system creates a Service Provider Digital Identity Token (S-DIT) (See description provided under FIG. 3). The S-DIT is an adaptation of the X.509 v3 digital certificate standard and contains the newly assigned CITA Registration ID and a hash of the CTI Module Device ID. In Step [11] the CITA system creates a Service Provider Registration Confirmation (S-RCON) token (See description provided under FIG. 3), which contains the S-DIT Token and the CITA Public key. The S-RCON Token is encrypted with the service provider's Public Key and digitally signed with the CITA Registration Private Key. In Step [12] the encrypted S-RCON token is then securely returned to the registration application on the service provider's electronic device.

In Step [13] the service provider's CITA registration application operating on their electronic device receives the encrypted S-RCON Token and uses the services provided under their CTI Module to validate the digital signature and decrypt the token content to extract the embedded S-DIT token. In Step [14] The S-DIT Token is securely stored in the CTI Module (or alternatively an Enterprise Security Server). In Step [15] the service provider provides payment for registering with the CITA system to complete the service provider registration process.

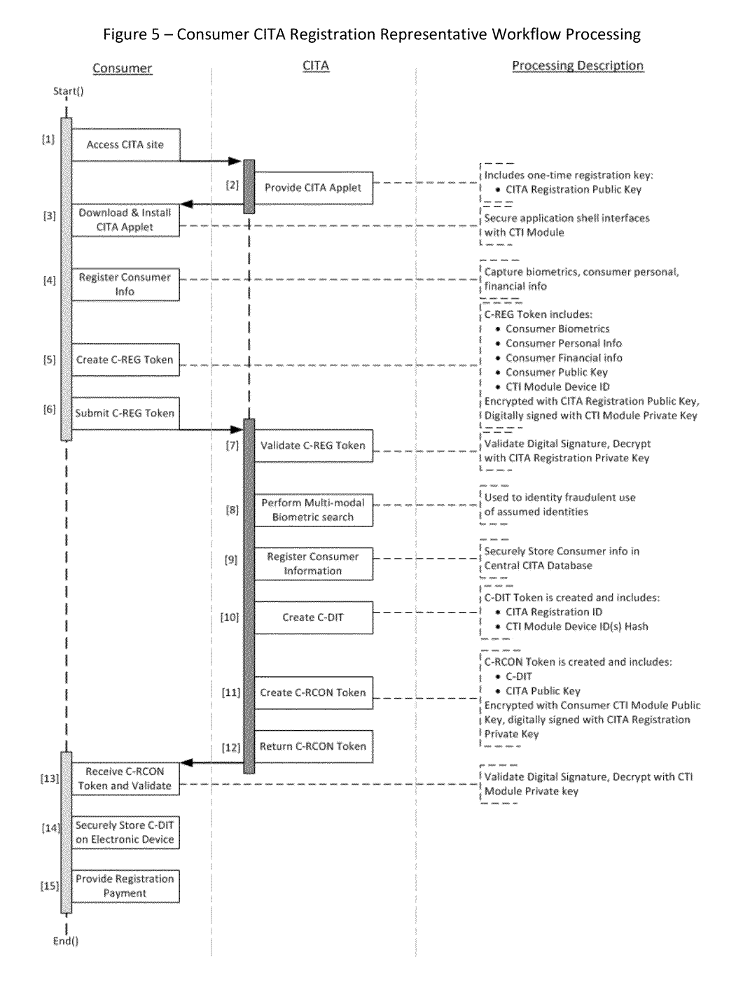

As depicted under FIG. 5, a consumer registers an account with the CITA system through a secure application operating on their electronic device. In Step [1] of the registration process the consumer accesses the CITA Third Party system web portal to create a new consumer account.

In Step [2] the CITA system provides the consumer with access to the registration software application, which can be downloaded and installed on the consumer's electronic device.

In Step [3] the consumer downloads and installs the registration software application on their electronic device. The downloaded registration module includes a one-time CITA Registration Public key, which will subsequently be used for encrypting all subsequent submissions between the consumer and CITA system. In Step [4] the consumer initiates the registration process and the CITA application interfaces with the CTI Module and requires the consumer to capture live biometric samples using their electronic device and supply additional biographic and financial information related to the consumer. This information gathering step also allows the consumer to define to identity attributes required to gain access to service provider services, e.g., user names, passwords, website URLS, etc., as well as financial accounts, e.g., credit card numbers, bank accounts, etc., that the consumer intends to use to provide payments for services provided from service providers. This action registers the CTI Module to the electronic device and securely maintains the captured information on the CTI Module. Subsequent access to the information will only be provided through multi-modal biometric authentication of the device owner. In Step [5] the registration module creates a Consumer Registration (C-REG) Token (See description provided under FIG. 3). The C-REG Token contains the consumer's captured biometric samples, personal information, financial information, the CTI Module Device ID, and a copy of the consumer's Public key (obtained from the CTI Module). The C-REG Token is encrypted and digitally signed by the CTI Module using the CITA Registration Public Key and the consumer's Private Key (maintained on the CTI Module). In Step [6] the encrypted C-REG Token is then securely submitted to the CITA system for processing.

In Step [7] the CITA system validates the digital signature and decrypts the token using the CITA Registration Private Key and validates the C-REG Token contents. In Step [8], under one instance of the invention, the CITA system may perform a multi-modal biometric search of the central CITA biometric repository using the registered biometric samples in order to detect and identify a consumer attempting to obtain cyberspace services under multiple assumed identities. This is an important security feature of the present invention as the capability ensures the identity of a consumer and guards against a consumer enrolling multiple times under multiple assumed identities. For example, without this feature a consumer could enroll multiple times and under multiple identities (with different ages) to fraudulently gain access to age restricted web sites, i.e., cyberspace predators. In Step [9] the CITA system assigns a unique CITA Registration ID and re-encrypts the consumer's information and stores the information in the central CITA repository. In Step [10] the CITA system creates a Consumer Digital Identity Token (C-DIT) (See description provided under FIG. 3). The C-DIT is an adaptation of the X.509 v3 digital certificate standard and contains the newly assigned CITA Registration ID and a hash of the CTI Module Device ID. In Step [11] the CITA system creates a Consumer Registration Confirmation (C-RCON) token (See description provided under FIG. 3), which contains the C-DIT Token and the CITA Public key. The C-RCON Token is encrypted with the consumer's Public Key and digitally signed with the CITA Registration Private Key. In Step [12] the encrypted C-RCON token is then securely returned to the registration application on the consumer's electronic device.

In Step [13] the consumer's CITA registration application operating on their electronic device receives the encrypted C-RCON Token and uses the services provided under their CTI Module to validate the digital signature and decrypt the token content to extract the embedded C-DIT token. In Step [14] the C-DIT Token is securely stored on the CTI Module. In Step [15] the consumer provides payment for registering with the CITA system to complete the consumer registration process.

The CITA system provides two basic types of services to the Service Provider/Consumer cyberspace community; Request Access Services and Request Payment Services.

### Request Access Services:

Request Access services are not limited to on-line accessibility as the services can be equally applied to merchant/retailer environments, i.e., gaining access to an age restricted location, like a movie theatre or nightclub. For example, access to a nightclub typically requires a consumer to present a driver's license where their age can be verified to be over 21, but providing this man-made token also presents the nightclub with additional information about the Consumer, to include their name, address, height, weight, etc. All that is really required to grant access to the club is confirmation that the individual is over 21, but under this example the consumer is required to divulge additional personal information attributes in order to gain accessibility to the requested service.

In today's society consumers wish to operate with a level of anonymity and pseudonymity, and they should not be required to divulge personal information that is not directly related to the service being requested. For this reason, this invention introduces the concept of “zeligmetrics”. The term is adopted from the 1984 Woody Allen movie “Zelig”, about a curiously nondescript enigma (Leonard Zelig) who is discovered for his remarkable ability to transform himself to resemble anyone in his immediate environment. The Merriam-Webster Dictionary defines the term “zelig” as; “A Chameleon like person who is unusually ubiquitous”. Thus, a zelig has multiple discrete identity attributes, the combinations of which are defined as “zeligmetrics”. Much like the chameleon, who has the ability to alter their identity attributes in order to blend into their immediate surroundings as a form of protection, today's security conscious consumers desire these same levels of protection when accessing service provider services in cyberspace.

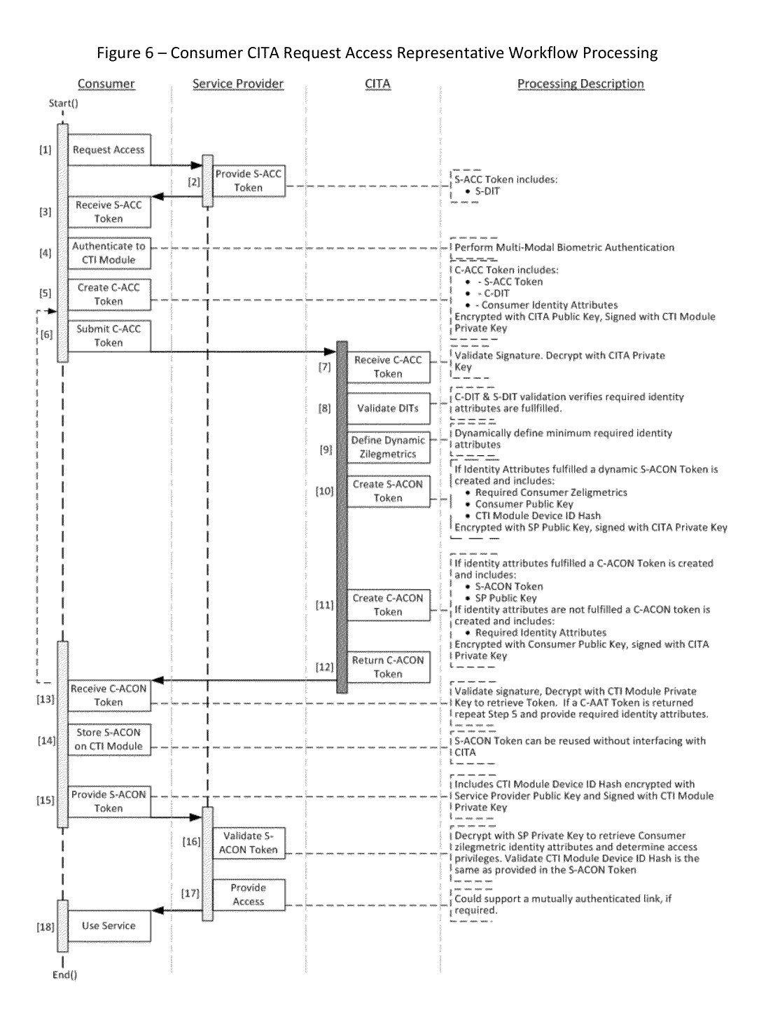

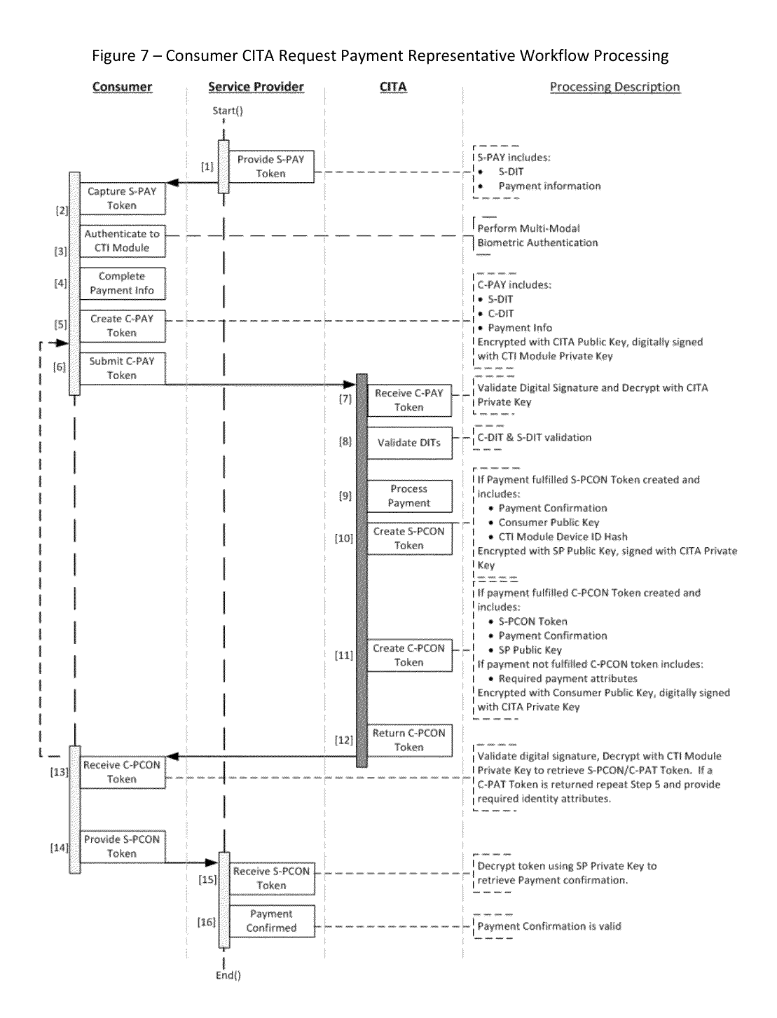

Gaining access to a service provider service (See FIG. 6) includes a number of steps under the present invention, which for the most part are fully automated. In Step [1] the consumer requests access to the service from a service provider. This could be an on-line access request to gain access to a web portal, or a retail access request, like the nightclub example cited above.

In response to this request, in Step [2], the service provider challenges the consumer to authenticate their identity. Typically this is in the form of a logon request for a website access, or the request to present a man-made token form of identification, i.e., a driver's license for accessing an age restricted club. Under this invention the need for these mechanisms are removed, as the service provider need only provide the consumer with a Service Provider Request Access (S-ACC) Token (See description provided under FIG. 3). The S-ACC contains the service provider's S-DIT, which contains minimal service provider identity attributes, i.e., CITA Registration Number, and a hash of registered CTI Module Device IDs.

In Step [3] the S-ACC Token is captured by the consumer using their CITA application operating on their CTI Module enabled, electronic device. This operation can be supported in a number of ways under the present invention. In one instance the S-ACC Token can be communicated electronically, e.g., in response to an online access request. In another instance the S-ACC Token can be imbedded in a 2-D barcode and captured by the consumer's CITA application operating on their electronic device, e.g., a smart phone. In Step [4], the capturing of the S-ACC token automatically launches the multi-modal biometric authentication capability from the consumer's CITA application operating on their electronic device. This process requires the consumer to present live biometric samples, which are then captured and used to authenticate against the consumer's registered biometric samples on their CTI module using multi-modal biometric matching capabilities. Thus, the consumer can only utilize their electronic device to authenticate their identity if the device's CTI module has been registered with their biometric samples. Once their identity is authenticated they are provided access to their Consumer Digital Identity Token (C-DIT) stored on their CTI module. In Step [5] the CITA application executing on the consumer's electronic device uses the CTI Module to create a Consumer Request Access (C-ACC) Token (See description provided under FIG. 3). This token includes the S-ACC Token, as well as a copy of the consumer's C-DIT, and any additional identity attributes required to gain access to the service provider's service. For example, if this was a new request to access a web site portal, the consumer may elect to provide the user name and password required to gain access if the information is already known. This would avoid the CITA system subsequently requesting the information from the consumer. To ensure privacy of the transaction the C-ACC Token is encrypted by the consumer's CTI Module using the CITA Public Key, and digitally signed using the consumer's Private Key that is registered on their Consumer's CTI module. In Step [6] the encrypted C-ACC Token is submitted electronically to the CITA system.

In Step [7] the CITA system receives the C-ACC. In Step [8] the CITA system validates the digital signature on the submission and uses the CITA Private Key to decrypt the submitted information and validates both S-DIT Token and C-DIT Token are authentic, i.e., the corresponding CITA registration numbers are valid and active accounts. In Step [9] the CITA system dynamically defines the minimal identity attributes required to gain access to the requested service. This process involves the determination of the zeligmetric identity attributes required by the service provider, and those to be provided from a consumer, in order for the consumer to gain access to the service. This automated determination is based upon the information provided by the service provider through their registration process. For instance, in the examples cited above, a web site provider may require a username and password to provide access to their web portal, whereas a nightclub owner only requires the consumer be of age 21 or older. The CITA system utilizes the identity attributes provided by the consumer through their registration process to satisfy this service request. As such, only the minimal required information (i.e., zeligmetric identity attributes) on the consumer are provided to the service provider.

In Step [10] the CITA system creates a Service Provider Access Confirmation (S-ACON) Token (See description provided under FIG. 3). The zeligmetric identity attributes defined under Step [9] are embedded in an S-ACON Token, as well as a hash of the Consumer's CTI Module Device ID and the consumer's CTI Module Public Key, and to ensure continued privacy of the transaction, the S-ACON Token is encrypted with the service provider's Public Key and digitally signed using the CITA Private Key. As such, the consumer has no way to alter the contents without the service provider detecting the modification. Note: Under Step [10] the consumer may not have the required identity attributes defined under their CITA registry. If this scenario occurs the CITA System creates a Consumer Access Attribute (C-AAT) Token (See description provided under FIG. 3), which identifies the missing identity attributes required to gain access to the requested service. In Step [11] the encrypted S-ACON Token (or the C-AAT Token if one was created) is embedded in a Consumer Access Confirmation (C-ACON) Token (See description provided under FIG. 3). The C-ACON Token is encrypted with the consumer's Public Key and digitally signed with the CITA's Private Key to ensure the integrity and privacy of the transaction. In Step [12] the C-ACON Token is securely returned to the consumer.

In Step [13] the consumer receives the C-ACON token via their electronic device and uses the CTI Module operating on their electronic device to validate the digital signature and decrypt the C-ACON token to obtain the S-ACON Token (or C-AAT Token if one was returned from the CITA). If the C-AAT Token was returned the CITA application operating on the consumer's electronic device uses the identity attribute tags in the C-AAT Token to prompt the consumer for the additional identity attributes required to gain access to the requested service. This action effectively transitions to Step [5] above and the process is repeated.

In Step [14], assuming an S-ACON Token was returned in the C-ACON Token, the S-ACON Token is saved to the CTI Module operating on the consumer's electronic device. This feature promotes ease of use under the present invention as the S-ACON token can be re-used by the consumer on any subsequent access request to the service provider's service without requiring the consumer to interface directly with the CITA system. For example, under Step [5] above, instead of creating a C-ACC token the CITA application operating on the consumer's electronic device could query the CTI Module to determine if an S-ACON Token has already been defined for the service provider. If it has, then Step [6] through Step [14] can simply be skipped and the S-ACON Token can be provided directly to the service provider.

In Step [15] the S-ACON Token is presented to the service provider. This action supports another important security feature introduced under the present invention, which requires the S-ACON Token to be coupled with the consumer's CTI Module Device ID.

Since a hash of the CTI Module Device ID has already been included within the S-ACON Token by the CITA System (under Step [10] above), and the S-ACON Token has been encrypted and digitally signed by the CITA so the consumer cannot alter the contents, by imbedding a second and separate copy of the hash of the consumer's CTI Module Device ID (which is encrypted using the consumer's CTI Module Private key and the Service Provider has access to the consumer's Public Key via the S-ACON token), the process enables the service provider to validate that the S-ACON token originated from the electronic device and CTI-Module registered under the consumer's CITA registry by simply comparing the two CTI Module Device IDs hash values. This security feature ensures that in the unforeseen chance that a consumer's S-ACON saved on their CTI Module token becomes compromised, (or knowingly shared between consumers as a means to fraudulently alter their identity) it cannot be re-used by any other consumer as the token is only valid if it originates from the electronic device that has the same CTI Module Device ID and only the true owner of said device can access the CTI module through multi-modal biometric authentication.

As with above, the presentation of the S-ACON Token to the service provider can take many forms; In one instance of the present invention the presentation can be submitted electronically, i.e., for an on-line web portal access request, or in another instance presented as a 2-D barcode, which can be captured by the service provider using their Point of Sale (POS) terminal. As the S-ACON Token has been encrypted and digitally signed in such a fashion as only the intended service provider recipient can validate and decipher the information the entire process ensures the consumer's information is safeguarded at all times.

In Step [16] the service provider receives the S-ACON Token, validates the digital signature and decrypts the token contents to extract the consumer's zeligmetric identity attributes, which are then compared against the service provider's required identity attributes to validate accessibility. This step also includes the service provider comparing the CTI Module Device ID hash from the S-ACON token to that which was separately provided by the Consumer with the S-ACON submission to ensure the S-ACON token originated from the registered CTI Module/electronic device. In Step [17], assuming the consumer's zeligmetric identity attributes meet the requirements of the service provider's accessibility attributes, the service provider provides the consumer with access to the requested service.

Finally, in Step [18] the consumer utilizes the requested service, without having to remember required identity attributes, openly divulge or exchange privacy information not directly related to the transaction, and without having to use man-made tokens of identity.

### Request Payment Services:

As with Request Access Services described above, Request Payment services are not limited to on-line transactions alone under the present invention, as the services can equally be applied to merchant/retailer environments, i.e., paying for a POS transaction at a restaurant. For example, typically when the restaurant meal is completed the consumer is presented with a check to pay for the service and the consumer presents a credit card to the server to cover the expense. The credit card is then used by the server to process the payment, the confirmation of which is presented to the consumer for signature. This typical scenario introduces a number of privacy vulnerabilities that lead to potential fraudulent use of the consumer's privacy information, to include; the consumer's financial account information on their credit card is made openly available, their name as displayed on the credit card is openly available, and they have openly left a recorded signature, which can be easily obtained as well. As today's consumers wishes to operate with a level of anonymity they should not be required to divulge such personal information that is not directly related to successfully processing the payment transaction. For this reason, this invention introduces the concept of a token-less payment process, whereby the CITA system performs the payment to the service provider on behalf of the consumer using the established digital identity tokens for each party. As such, the only information exchanged between the consumer and the service provider is their digital identity tokens and the final confirmation that the payment has been successfully completed.

Processing a Request Payment Service transaction (See Drawing 7) includes a number of steps under the present invention, which for the most part are fully automated. In Step [1] the service provider provides the consumer with a Service Provider Request Payment (S-PAY) Token (See description provided under FIG. 3). The S-PAY Token can be presented as an electronic token, e.g., a payment request for an on-line transaction and containing the expense amount and the service provider's Digital Identity Token (S-DIT), or a paper token, e.g., a paper receipt for a meal at a restaurant, which contains a 2D barcode representation of the expense amount and the service provider's Digital Identity Token (S-DIT).

In Step [2] the S-PAY Token is captured by the consumer using their CITA application operating on their CTI Module enabled, electronic device. This operation can be supported in a number of ways under the present invention. In one instance of the invention the S-PAY Token can be communicated electronically, i.e., for an online web portal payment. In another instance the S-PAY Token can be imbedded in a 2D barcode on a POS terminal receipt and captured by a consumer's CITA application operating on their electronic device, e.g., smart phone. In yet another instance the S-PAY Token can be provided in a barcode format and the expense information can be provided separately, e.g., the register total or a printed receipt.

In Step [3], the capturing of the S-PAY token automatically launches the multi-modal biometric authentication capability from the consumer's CITA application operating on the consumer's electronic device. This process requires the consumer to present live biometric samples, which are then captured and used to authenticate against the consumer's registered biometric samples on their CTI module using multi-modal biometric matching capabilities. Thus, the consumer can only utilize their electronic device to authenticate their identity if the device's CTI module has been registered with their biometric samples. Once their identity is authenticated they are provided access to their Consumer Digital Identity Token (C-DIT) stored on their CTI module.

In Step [4] the CITA application executing on the consumer's electronic device provides the ability for the consumer to complete the payment information, which would include identifying the registered financial account, i.e., credit card, to cover the payment, as well as define any gratuities or extra fees to be added to the payment.

In Step [5] the CITA application executing on the consumer's electronic device interfaces with the CTI Module to create a Consumer Request Payment (C-PAY) Token (See description provided under FIG. 3). This token includes the S-PAY Token, a copy of the consumer's C-DIT, as well as the consumer supplied payment information. The CTI Module encrypts the C-PAY Token using the CITA Public Key and digitally signs the submission packet using the Consumer's Private Key that is registered on the consumer's CTI Module. In step [6] the C-PAY Token is securely submitted to the CITA system for processing.

In Step [7] the CITA system receives the C-PAY Token, validates the digital signature, and decrypts the submission using the CITA Private Key.

In Step [8] the consumer C-DIT and service provider S-DIT are validated for authenticity, i.e., the corresponding CITA registration numbers are valid and active accounts.

In Step [9] the payment transaction is processed. The processing of the payment can be supported in a number of ways under the present invention. In one instance the CITA system interfaces with the financial institutions registered under the consumer's and service provider's CITA accounts to debit the consumer's account and credit the service provider's account. In another instance the CITA system can maintain financial accounts on behalf of the consumer and service provider and debit/credit the accounts directly, thereby avoiding and eliminating the additional expenses associated with electronic credit/debit card payments typically passed on to the consumer and/or service provider. This feature is intended to attract both consumers and service providers to utilize the CITA services.

In Step [10] the CITA system builds a Service Provider Payment Confirmation (S-PCON) Token (See description provided under FIG. 3), which contains a unique payment confirmation identifier, the consumer's Public key, and a hash of the Consumer's CTI Module Device ID. The S-PCON Token is encrypted using the service provider's Public key and digitally signed using the CITA Private Key to maintain adequate levels of privacy and to ensure the consumer has no way to alter the token contents as a means of fraudulently and falsely presenting the payment as being successfully processed. Note: Under Step [10] the consumer's registered financial information may be invalid to complete the automated payment process, e.g., a credit card has expired. If this scenario is encountered the CITA System creates a Consumer Payment Attribute (C-PAT) Token (See description provided under FIG. 3), which identifies the missing payment attributes required to successfully pay for the service.

In Step [11] the CITA system creates a Consumer Payment Confirmation (C-PCON) Token (See description provided under FIG. 3), which includes the encrypted S-PCON Token (or the C-PAT Token if one was created), the payment confirmation information, and a copy of the Service Provider's Public key. The C-PCON token is encrypted with the consumer's Public Key and digitally signed with the CITA's Private Key to ensure the integrity and privacy of the transaction. In Step [12] the C-PCON Token is securely returned to the consumer.

In Step [13] the C-PCON Token is received by the Consumer's CITA application operating on their electronic device and the digital signature is validated through their CTI module and the contents of the token are decrypted using the Consumer's CTI module Private Key to obtain the S-PCON Token (or C-PAT Token if one was returned from the CITA). If a C-PAT Token was returned the CITA application operating on the consumer's electronic device uses the payment attribute tags in the C-PAT Token to prompt the consumer for the additional payment attributes required to complete the payment request. This action effectively transitions to Step [5] above and the process is repeated.

In Step [14] the consumer provides the S-PCON Token to the service provider. Presentation of the S-PCON Token to the service provider can take many forms under the present invention. In one instance the encrypted token is submitted electronically to the service provider, e.g., for payment of an on-line transaction. In another instance the S-PCON Token can be presented in a 2D barcode format display from the consumer's electronic device via their CITA application, which can then be captured electronically using a service provider's electronic device. Yet in another instance the consumer can simply record the payment confirmation ID on the printed check, which would serve the scenario where a service provider does not have the ability to capture S-PCON Tokens electronically.

In Step [15] the Service Provider receives and validates the S-PCON Token. This process would include validating the digital signature of the submission and decrypting the data contents (assuming an electronic submission), to extract the payment confirmation ID.

In Step [16] the Service Provider confirms the payment has been completed successfully to end the transaction without having the consumer openly divulge or exchange privacy information not directly related to the transaction and without having to use man-made tokens, e.g., a credit/debit card to pay for the service.

What is claimed is:

1. A method and system providing for the establishment of trusted identities between two cyberspace parties and the secure processing of cyberspace transactions, said transactions comprising at a minimum service requests and/or payment requests, without the need for either party to openly divulge or exchange personal identifier and/or financial account information.

2. The System of claim 1, wherein said System is comprised of the following components; a Network of Consumers, a Network of Service Providers, and a Cyberspace Identification Trust Authority (CITA) System, all interconnected through the Internet or an Intranet.

3. The System of claim 1, wherein said System utilizes a new identity authentication methodology based upon the “Validation of Light Transfer Zeligmetrics” (VOLTZ) protocol, to establish trusted identities between said System components. Said method supporting cyberspace user identity authentication using Digital Tokens, and said method using the minimal amount of identity attributes required to authenticate said cyberspace user, and said identity attributes being based upon Zeligmetrics.

4. The CITA System of claim 2 wherein said CITA System is further comprised of a Primary site and a redundant Backup site for high-availability operations, wherein each site is further comprised of a Server Farm, Load Balancers, Network Switches and Routers, a Network LAN/WAN Infrastructure, and connectivity to the Internet, or an Intranet.

5. The CITA System of claim 2, wherein said CITA System provides access to a Software Application that can be downloaded and installed on an electronic device, and said Software Application providing access to said CITA System using the Internet or an Intranet.

6. The CITA System of claim 2, wherein said CITA System supports a method for processing CITA Cyberspace Transactions, and said transactions supporting at a minimum; a Registration Method, a Request Access Method, and a Request Payment Method.

7. The CITA System of claim 2, wherein said CITA System supports a method for processing electronic payment requests through accounts established directly with said CITA System, or through an external interface to electronic commerce payment service provider systems and/or financial institution systems using established credit/debit financial accounts.

8. The CITA System of claim 2, wherein said CITA System utilizes PKI, digital signature, data hashing, data encryption, Multi-Modal Biometric Identification, and Credit Background Checking Methodologies to support the establishment of; a trusted cyberspace user identities; mutually authenticated and secured communication links between two cyberspace parties; and the exchange of encrypted and digitally signed data packets to guarantee transaction privacy and integrity between said cyberspace parties.

9. The CITA System of claim 2, wherein said CITA System supports data mining methodologies and the ability to archive transaction metrics and generate Business Intelligence (BI) reports and analytical data pertaining to CITA cyberspace transactions.

10. The Network of Consumers of claim 2, wherein said Network of Consumers comprises; at least one cyberspace user requesting access to services, or requesting payment for services, provided by a cyberspace service provider, and said consumer having registered an account the CITA System of claim 2.

11. The Network of Service Providers of claim 2 wherein said Network of Service Providers comprises; at least one cyberspace user providing cyberspace services or accepting payment for services provided, and said service provider having registered an account with the CITA System of claim 2.

12. The Network of Service Providers of claim 2, wherein said Network of Service Providers comprises at least one Web Service Provider and/or one Retailer/Merchant Service Provider.

13. The Digital Tokens of claim 3, wherein said Digital Tokens are comprised of a data container, said data container being based upon a defined structure format, said format containing defined data elements, and said data elements including but being limited to; digital certificates, encrypted data objects, data hash values, and any other data elements required to process the CITA Cyberspace Transactions of claim 6, and said Data Tokens at a minimum being comprised of; a Service Provider Registration (S-REG) Token, a Consumer Registration (C-REG) Token, a Service Provider Registration Confirmation (C-RCON) Token, a Consumer Registration Confirmation (C-RCON) Token, a Service Provider Digital Identity (S-DIT) Token, a Consumer Digital Identity (C-DIT) Token, a Service Provider Request Access (S-ACC) Token, a Consumer Request Access (C-ACC) Token, a Consumer Access Attribute (C-AAT) Token, a Service Provider Access Confirmation (S-ACON) Token, a Consumer Access Confirmation (C-ACON) Token, a Service Provider Request Payment (S-PAY) Token, a Consumer Request Payment (C-PAY) Token, a Consumer Payment Attribute (C-PAT) Token, a Service Provider Payment Confirmation (S-PCON) Token, and a Consumer Payment Confirmation (C-PCON) Token.

14. The Server Farm of claim 4 wherein said Server Farm comprises; a database engine to store registration sets of identity attributes and Biometric Samples, a registration set provided by at least one cyberspace consumer and one cyberspace service provider; a Biometric Comparator engine to compare live and registered biometric samples and establish unique identities across registered cyberspace consumers and service providers; a Registration engine to process consumer and service provider registration requests, said registration process including biometric matching services, validation of identity through credit background checks and other means, and the assignment of unique digital identities; an Access Services engine to process consumer requests for access to service provider services, and the creation of dynamic digital identity tokens containing the minimal identity attributes required to successfully execute the service access request; a Payment Services engine to process consumer requests for payment of services provided by service providers, said Payment Service engine optionally supporting external interfaces to electronic commerce service payment providers and financial institutions, and/or the ability to process payments via accounts held and maintained by the CITA System of claim 2; a Web Server engine providing Internet/Intranet connectivity between said CITA System, the Network of Consumers of claim 2, and the Network of Service Providers of claim 2; and a Security engine providing digital signature, data encryption and PKI key management and processing services.

15. The Software Application of claim 5, wherein said Software Application can be hosted on an Electronic Device, supports the ability to capture biometric samples from the electronic device owner, supports the ability to interface with a Security Module configured on the electronic device, supports the ability to register device Owner Data to said Security Module on said device, supports the ability to interface with the CITA System of claim 2 to process CITA transactions, and supports the ability to utilize the Internet or an Intranet to electronically communicate with a cyberspace consumer and/or cyberspace service provider.

16. The Security Module of claim 15, wherein said Security Module is herein referred to as the CTI Module, as described under USPTO Non-Provisional patent application Ser. No. 13/744,369—Cyberspace Trusted Identity (CTI) Module.

17. The Software Application of claim 5, wherein said Software Application supports the ability to capture the Service Provider Request Access (S-ACC) token of claim 13 and the Service Provider Request Payment (S-PAY) Token of claim 13 using an electronic communications methodology. Said methodology including but not being limited to; passing the token in an electronic message, e.g., through a web browser session requesting access to a web portal or payment for services offered on-line; and/or through the scanning of a barcode image which embeds said S-ACC or S-PAY token, e.g., using a smart phone at a Point-of-Sale (POS) payment terminal.

18. The Registration Method of claim 6, wherein said Registration Method supports the ability for a cyberspace user to register an account with the CITA System of claim 2. Said cyberspace user being either a Consumer or Service Provider of cyberspace services, and said cyberspace user being referred herein after as the Registering Party.

19. The Registration Method of claim 6, wherein the Registering Party of claim 18 uses the Software Application of claim 5 to create a CITA registration token, i.e., the Service Provider Registration (S-REG) Token of claim 13 for service providers or the Consumer Registration (C-REG) Token of claim 13 for consumers. Said token containing biometric samples, personal information, financial information, the unique Public Key from said Registering Party's CTI Module or enterprise security framework, and/or the CTI Module Device ID, and said token being encrypted with a CITA Registration Public Key and digitally signed by said Registering Party using their CTI Module Private Key or Enterprise Security framework Private Key, and said transaction being submitted to the CITA System of claim 2 for processing.

20. The Registration Method of claim 6, wherein a CITA registration token, i.e., the Service Provider Registration (S-REG) Token of claim 13 for service providers or the Consumer Registration (C-REG) Token of claim 13 for consumers, is submitted to the CITA System of claim 2. Said token being processed by said CITA System and said processing including but not being limited to; a digital signature validation process; a Multi-Modal Biometric Identification Process; a Credit Background Check process; the creation of a unique CITA Digital Identity Token, i.e., the Service Provider Digital Identity (S-DIT) Token of claim 13 for service providers or the Consumer Digital Identity (C-DIT) Token of claim 13 for consumers, and containing the Registering Party's CITA Registration ID and a hash of the Registering Party's CTI Module Device IDs; the embedding of said Digital Identity Token in a CITA Registration Confirmation, i.e., the Service Provider Registration Confirmation (S-RCON) Token of claim 13 for service providers or the Consumer Registration Confirmation (C-RCON) Token of claim 13 for consumers, wherein said CITA Registration Token contains said CITA Digital Identity Token and a unique CITA Public Key, is encrypted with the Registering Party's Public Key, and digitally signed with the CITA Private key, and returned to the Registering Party. Said Registering Party receiving said CITA Registration Confirmation Token using the Software Application of claim 5, validating the digital signature of said CITA System, decrypting said CITA Registration Confirmation Token contents to extract the embedded CITA Digital Identity Token and CITA Public Key, and storing the CITA Digital Identity Token and CITA Public Key on their CTI Module, and/or enterprise security server, for subsequent CITA transaction processing.

21. The Request Access Method of claim 6, wherein said method is initiated when a Consumer requests access to a Service Provider's service, said Service Provider providing the CITA Service Provider Request Access (S-ACC) Token of claim 13 to the Consumer in response to said request, and said token including the Service Provider CITA Digital Identity (S-DIT) Token of claim 13, which is encrypted with the CITA Public Key and digitally signed with the Service Provider's Private Key. Said Consumer using the Software Application of claim 5 to Biometrically Authenticate their Identity to the CTI Module on their electronic device, using said software application to electronically capture said S-ACC Token, and using the CTI Module to generate the CITA Consumer Request Access Token (C-ACC) of claim 13, which imbeds said S-ACC Token and includes a copy of the Consumer's CITA Digital Identity (C-DIT) Token of claim 13, and may include additional identity attributes, as supplied by the Consumer. Said C-ACC Token being encrypted with the CITA Public Key and digitally signed with the Consumer's CTI Module Private Key, and submitted to the CITA System of claim 2 for processing. Said CITA System processing said C-ACC Token, which includes, but is not limited to; digital signature validation of the submission packet; validation of the submitting CTI Module Device ID; validation of the embedded S-DIT and C-DIT tokens; the dynamic creation of the Consumer's Zeligmetric Identity Attributes; and the creation of the Service Provider Access Confirmation (S-ACON) Token of claim 13. Said S-ACON Token including the Consumer's CITA generated zeligmetric identity attributes, Consumer CTI Module Public Key, and a hash of the Consumer's CTI Module Device ID. Said S-ACON Token being encrypted with the CITA Service Provider's Public Key, digitally signed with the CITA Private Key, and embedded in the Consumer Access Confirmation (C-ACON) Token of claim 13, which is encrypted with the Consumer's CTI Module Public Key, digitally signed with the CITA Private Key, and returned to the Consumer. Said C-ACON Token being received by the Consumer using said software application on their electronic device, and said application using the Consumer's CTI Module to validate the digital signature and decrypt said C-ACON token contents to extract the embedded S-ACON token. Said S-ACON token being presented to the Service Provider by the Consumer using said software application and said Service Provider receiving said S-ACON token, validating the digital signature of said CITA System, performing a CTI Module Device ID Hash Validation Process, and decrypting said S-ACON token contents to extract the Consumer's zeligmetric identity attributes. Comparing said identity attributes to the Service Provider's required identity attributes to determine accessibility to the requested service. Said Service Provider granting access to the requested service if the offered identity attributes match the required attribute criteria and denying access if the attributes do not fulfil the identity attribute requirements.

22. The Request Access Method of claim 6, wherein said method supports the ability to reuse the Service Provider Access Confirmation (S-ACON) of claim 13 for subsequent access requests to the same service provider's service. Said S-ACON token being stored locally on the Consumer's CTI Module during the initial access request when the said token was created by the CITA System of claim 2, and maintained in an encrypted format so only the service provider can interpret the tokens contents.

23. The Request Payment Method of claim 6, wherein said method is initiated when a Consumer requests payment to a Service Provider for services provided, said Service Provider providing the CITA Service Provider Request Payment (S-PAY) Token of claim 13 to the Consumer in response to said request, and said token including the Service Provider CITA Digital Identity (S-DIT) Token of claim 13 and the Service Provider Payment Information Details, encrypted with the CITA Public Key and digitally signed with the Service Provider's Private Key. Said Consumer using the Software Application of claim 5 to electronically capture said S-PAY Token and generating the CITA Consumer Request Payment Token (C-PAY) of claim 13. Said C-PAY token imbedding said S-PAY Token and including a copy of the consumer's CITA Consumer Digital Identity (C-DIT) Token of claim 13, and the Consumer's Payment Information Details. Said C-PAY Token being encrypted with the CITA Public Key and digitally signed with the Consumer's CTI Module Private Key, and submitted to the CITA System of claim 2 for processing. Said CITA System processing said C-PAY Token, which includes, but is not limited to; digital signature validation of the submission packet; performing a CTI Module Device ID Hash Validation Process; validation of the embedded S-DIT and C-DIT tokens; the electronic payment processing to satisfy the payment request; and the creation of the Service Provider Payment Confirmation (S-PCON) Token of claim 13. Said S-PCON Token including the payment confirmation number, Consumer CTI Module Public Key, and a hash of the Consumer's CTI Module Device ID. Said S-PCON token being encrypted with the CITA Service Provider's Public Key, digitally signed with the CITA Private Key, and together with the payment confirmation number being embedded in the Consumer Payment Confirmation (C-PCON) Token of claim 13. Said C-PCON token being encrypted with the Consumer's CTI Module Public Key, digitally signed with the CITA Private Key, and returned to the Consumer. Said C-PCON Token being received by the Consumer using said software application on their electronic device, and said application validating the digital signature and decrypting the token contents to extract the embedded S-PCON token. Said S-PCON token being presented to the Service Provider by the Consumer using said software application and said Service Provider receiving said S-PCON token, validating the digital signature of said CITA system, performing a CTI Module Device ID Hash Validation Process, and decrypting the token contents to extract the payment confirmation number to confirm payment for the service provided.

24. The Web Service Provider of claim 12, wherein said Web Service Provider may be comprised of Network Switches/Routers, Firewalls, a Web Server Farm, and a Web Server Provider LAN/WAN providing connectivity to the Internet or an Intranet and offering cyberspace services to the cyberspace user community.

25. The Retailer/Merchant Service Provider of claim 12, wherein said Retailer/Merchant Service Provider may be comprised of Network Switches/Routers, Firewalls, a Point of Sale (POS) terminal, a Retailer/Merchant, and a Retailer/Merchant Service provider LAN/WAN providing connectivity to the Internet or an Intranet and providing goods and/or services to the cyberspace user community.

26. The Biometric Samples of claim 14, wherein said Biometric Samples include both physical Biometric Modalities, which may include but are not limited to; fingerprint; face; DNA; iris; retina; vein; skin spectroscopy; and pulse electrocardiogram modalities, and behaviour biometric modalities, which may include but are not limited to; gate; keystroke; voice; signature; and eye movement modalities.

27. The Electronic Device of claim 15, wherein said Electronic Device can be any form of computing device with an operating system, CPU, memory, system bus, Internet/Intranet connectivity, and/or display, and may include a desktop PC, laptop PC, tablet PC, smart phone, or other iterations of electronic devices supporting electronic computing and electronic communication mechanisms.

28. The Owner Data of claim 15, wherein said Owner Data may include name, phone numbers, addresses, email addresses, date of birth, financial account information, medical account information, insurance account information, club membership information, retailer account information, travel document information, web site portal information, CITA digital identity tokens, and any other information an electronic device owner may wish to securely store on their CTI Module.

29. The Multi-modal Biometric Identification method of claim 20, wherein the CITA System of claim 2 maintains a repository of biometric sample records for registered CITA users and biometric samples provided in new CITA registration requests are biometrically matched against said registered samples using multi-modal biometric identification technology. Said multi-modal biometrics comprising the Biometric Modalities of claim 26, and said multi-modal biometric identification matching providing the ability to uniquely identify and authenticate the identity of a CITA registered user.

30. The Credit Background Check method of claim 20, wherein the CITA System of claim 2 may utilize external credit checking services as a means of establishing and/or authenticating the identity of a CITA registered user. Said Credit Background Check process utilizing the biographical and financial account information provided by the CITA user under their registration request packet.

31. The CITA Registration ID of claim 20, wherein said ID is based upon alphanumeric characters, is generated by the CITA System of claim 2 upon a successful CITA registration transaction, is assigned to the registered CITA user, and used to uniquely identify said user.

32. The Service Provider Digital Identity (S-DIT) Token of claim 20, wherein said token is generated by the CITA System of claim 2 to uniquely identify the Service Provider. Said token containing the unique CITA Registration ID of claim 31, and the Service Provider's registered CTI Module Device IDs.

33. The Consumer Digital Identity (C-DIT) Token of claim 20, wherein said token is generated by the CITA System of claim 2 to uniquely identify the Consumer. Said token containing the unique CITA Registration ID of claim 31, and the Consumer's registered CTI Module Device IDs.

34. The Biometric Authentication of Identity method of claim 21, wherein the Software Application of claim 5 requires the owner to authenticate their identity to their electronic device CTI Module using multi-modal biometric identification technology in order to gain access to said module.

35. The Dynamic Creation of Consumer Zeligmetric Identity Attributes method of claim 21, wherein the CITA System of claim 2 performs a dynamic assessment of the identity attributes required by a service provider to grant access to their service, against the discrete identity attributes as provided by a consumer when they registered with said CITA System or requested access to said service of the service provider. Said assessment generating the minimal identity attributes required to satisfy the service provider's identity authentication requirements.

36. The Zeligmetric Identity Attributes of claim 21, wherein said zeligmetric identity attributes are based upon a unique identity characteristic of a zelig, e.g., user name password, age, gender, email address, phone number, social security number, passport number, etc. Said zelig being defined as “A Chameleon like person who is unusually ubiquitous”. Thus, a zelig has multiple discrete identity attributes, the combinations of which are defined as “zeligmetrics” and the use of said zeligmetrics in a discrete manner providing the ability for a cyberspace user to operate with a level of anonymity and pseudonymity within cyberspace, and be present within multiple cyberspace environments at the same time using different zeligmetric identity attributes as a mechanism to safeguard their personal identity and ensure only those identity attributes required to complete a cyberspace transaction are exchanged between two cyberspace parties.

37. The CTI Module Device ID Hash Validation method of claim 21, wherein the CITA transactions exchanged between a Consumer and Service Provider contain separate embedded hashes of the Consumer's CTI Module Device ID, one encrypted by the CITA System of claim 2 using the Service Provider's Public key such that only the Service Provider can decipher, and one presented by the Consumer. Thus, the Service Provider is provided a mechanism to authenticate the CITA token offered by the Consumer by comparing the two hash values in order to validate the offered token originated from the Consumer's CTI Module, and is not a fraudulent token presented as a means of masking the consumer's identity or presenting false payment for services provided.

38. The Service Provider Payment Information Details of claim 23, wherein a Service Provider identifies the total payment to be made by the Consumer for services provided. Said information including but not being limited to; merchandise, food, beverages, tax, fees, gratuities, services, etc.

39. The Consumer Payment Information Details of claim 23, wherein a Consumer using the Software Application of claim 5 on their electronic device can identify; the financial account to be used in providing payment for service provider services, the payment to be made, and any additional payments to be included, e.g., gratuities, fees, etc.
